(19) United States
(12) Patent Application Publication
(10) Pub. No.: US 2026/0149985 A1
(43) Pub. Date: May 28, 2026

(54) SENSING METHOD AND CORRESPONDING APPARATUS

(71) Applicant: HUAWEI TECHNOLOGIES CO., LTD., Shenzhen (CN)

(72) Inventors: Zhongfeng Li, Shanghai (CN); Wen Tong, Ottawa (CA); Jianglei Ma, Ottawa (CA)

(73) Assignee: HUAWEI TECHNOLOGIES CO., LTD., Shenzhen (CN)

(21) Appl. No.: 19/456,486

(22) Filed: Jan. 22, 2026

Related U.S. Application Data
(63) Continuation of application No. PCT/CN2023/108792, filed on Jul. 24, 2023.

(51) Int. Cl. H04W 24/02

(52) U.S. Cl. CPC H04W 24/02

(57) ABSTRACT

A method includes: obtaining at least two sets of parameter configurations, where the at least two sets of parameter configurations include a first parameter configuration for sensing and a second parameter configuration for sensing, the first parameter configuration includes a first subcarrier spacing SCS, the second parameter configuration includes a second SCS, and the first SCS is greater than the second SCS; and performing sensing based on the at least two sets of parameter configurations. A sensing and detection distance is restricted by a length of an OFDM symbol, and the length of the OFDM symbol is usually a reciprocal of an SCS.

### CROSS-REFERENCE TO RELATED APPLICATIONS

This application is a continuation of International Application No. PCT/CN2023/108792, filed on Jul. 24, 2023, the disclosure of which is hereby incorporated by reference in its entirety.

### TECHNICAL FIELD

This application relates to the field of communication technologies, and specifically, to a sensing method and a corresponding apparatus.

### BACKGROUND

With large-scale popularization of internet applications and terminal devices, people's requirements on wireless communication further increase. Communication technologies are also continuously evolving and developing. In addition to stronger communication capabilities, future communication systems may also have sensing capabilities. The communication systems are usually systems with integrated sensing and communication.

Based on the integrated sensing and communication, transmission, reflection, and scattering of radio waves may be used to sense and describe an environment, perform high-precision positioning and tracking, and also perform imaging, mapping, and positioning, to enhance human senses for gesture and activity recognition and the like.

Therefore, how to perform sensing becomes an urgent problem to be resolved.

### SUMMARY

This application provides a sensing method, to improve a sensing and detection range. This application further provides a corresponding communication method, a communication apparatus, a computer-readable storage medium, and a computer program product.

According to a first aspect of this application, a sensing method is provided, and includes: obtaining at least two sets of parameter configurations, where the at least two sets of parameter configurations include a first parameter configuration for sensing and a second parameter configuration for sensing, the first parameter configuration includes a first subcarrier spacing (SCS), the second parameter configuration includes a second SCS, and the first SCS is greater than the second SCS; and performing sensing based on the at least two sets of parameter configurations.

The method may be performed by a first apparatus. The first apparatus may be a communication device, or may be a communication apparatus that can support the communication device in implementing a function required in the sensing method, for example, a chip. For example, the first apparatus is a terminal device/access network device, a chip that is arranged in the terminal device/access network device and that is configured to implement a function of the terminal device/access network device, or another component configured to implement the function of the terminal device/access network device. In the following description process, an example in which the first apparatus is the terminal device/access network device is used for description. It should be noted that, the first apparatus may alternatively be a dedicated sensing device.

In the foregoing method, sensing is performed by configuring the at least two sets of parameter configurations. In this way, there may be at least two SCSs, and sizes of the at least two SCSs are different. A sensing and detection distance is restricted by a length of an orthogonal frequency division multiplexing (OFDM) symbol, and the length of the OFDM symbol is usually a reciprocal of an SCS. Therefore, a larger first SCS corresponds to a shorter symbol length, to sense and detect a minimum distance as short as possible, and a smaller second SCS corresponds to a longer symbol length, to obtain higher symbol energy on a receiving side, and sense and detect a longer distance. In this way, a sensing and detection range is increased.

In an embodiment, the first SCS is a largest SCS in SCSs supported by at least one frequency band in an active state; or the first SCS is one SCS in SCSs supported by a frequency band in an inactive state.

In this application, the frequency band may be a carrier, or may be a bandwidth part (BWP).

In an embodiment, the SCS of the frequency band in the active state may be different from the SCS of the frequency band in the inactive state. Usually, the communication apparatus preferentially selects the largest SCS in the SCSs supported by the frequency band in the active state. If the largest SCS meets a sensing requirement, the largest SCS in the SCSs supported by the frequency band in the active state may be used as the first SCS. Because the length of the OFDM symbol is usually the reciprocal of the SCS, a larger first SCS indicates a smaller length of the OFDM symbol. In this way, the minimum distance as short as possible can be sensed, to reduce a distance blind area. The second SCS is less than the first SCS, so that the second parameter configuration may be for sensing and detecting a long target distance, or may be for sensing and detecting a maximum distance (to increase a maximum unambiguous range). In this way, the sensing and detection range can be increased.

In an embodiment, the first SCS is one SCS in SCSs supported by a frequency band in an inactive state, and the one SCS supported by the frequency band in the inactive state is greater than an SCS supported by a frequency band in an active state.

In an embodiment, if a largest SCS in SCSs supported by the frequency band in the active state does not meet a sensing requirement, any SCS that is in the SCSs supported by the frequency band in the inactive state and that is greater than the SCS supported by the frequency band in the active state may be selected as the first SCS. To reduce a distance blind area by using an SCS as large as possible, a largest SCS in the SCSs supported by the frequency band in the inactive state may be selected as the first SCS. The first SCS may be determined by the communication apparatus for sensing, and is for performing the foregoing sensing process; or may be determined by another sensing management apparatus, and then is notified to the communication apparatus for sensing by using configuration signaling.

In an embodiment, the first parameter configuration further includes a first cyclic prefix (CP), the second parameter configuration further includes a second CP, the first CP corresponds to the first SCS, the second CP corresponds to the second SCS, and the first CP is less than the second CP.

In an embodiment, the first CP and the second CP may be for reducing multipath interference of a return signal of a sent sensing signal.

In an embodiment, the first CP is a first product; and the first product is a product of a normal CP corresponding to the first SCS and α, and 0≤α<1.

In an embodiment, the first CP is obtained based on the product of a and the normal CP. In such a configuration, a length of the sensing signal can be as small as possible, so that a sensed and detected distance can be as short as possible.

In an embodiment, the second CP is a second product; and the second product is a product of a normal CP corresponding to the second SCS and β, or a product of a physical random access channel (PRACH) CP corresponding to the second SCS and β, and β>1.

In an embodiment, the second CP is obtained based on the product of β and the normal CP or the PRACH CP. Such a long CP configuration is equivalent to increasing the length of the OFDM symbol. In this way, multipath interference of reflection can be eliminated, and in a same quantity of transmission times, a longer symbol can also bring higher receiving energy, to support a longer sensing and detection distance.

In an embodiment, the first parameter configuration further includes a length of a first receive window; and the length of the first receive window is not less than a sum of a length of a first symbol and twice a length of the first CP, and the length of the first symbol is a reciprocal of the first SCS; or the length of the first receive window is N times the length of the first symbol, and N>1.

In an embodiment, a length of a receive window (Rx window) is a configured time length for receiving a return signal, where the return signal is a multipath signal corresponding to a transmitted sensing signal, like a reflected signal or a diffracted signal. If a delay difference between arrival time of different multipath signals is in a range of the first CP, the length of the first receive window is not less than the sum of the length of the first symbol and twice the length of the first CP. In this way, a target of a multipath delay in the first CP can be sensed in duration of the first receive window. If the delay difference between the arrival time of the different multipath signals is greater than the length of the first symbol, and the multipath signals do not interfere with each other, the length of the first receive window may be N times the length of the first symbol. In this way, the longer sensing and detection distance can be supported.

In an embodiment, the second parameter configuration further includes a length of a second receive window; and the length of the second receive window is not less than a sum of a length of a second symbol and twice a length of the second CP, and the length of the second symbol is a reciprocal of the second SCS; or the length of the second receive window is not less than a sum of twice the length of the second CP and a length of (M+1) second symbols, M is an integer, and M≥2.

In an embodiment, if the delay difference between the arrival time of the different multipath signals is in a range of the second CP, the length of the second receive window is not less than the sum of the length of the second symbol and twice the length of the second CP. In this way, a target of the multipath delay in the second CP can be sensed in duration of the second receive window. If the length of the second receive window is not less than the sum of twice the length of the second CP and the length of the (M+1) second symbols, a sensing and detection distance can be increased, and requirements for more different coverage distances can be met.

In an embodiment, a length of a transmit symbol of a sensing signal obtained based on the second parameter configuration is not greater than the length of the first receive window, and the first receive window is a receive window of a sensing signal using the first parameter configuration.

In an embodiment, that the length of the transmit symbol of the sensing signal obtained based on the second parameter configuration is not greater than the length of the first receive window may be described as follows: By using respective start time of the sensing signals of the two parameter configurations as a reference, start time of the second receive window of the sensing signal of the second parameter configuration is not later than end time of the first receive window of the sensing signal using the first parameter configuration. In this way, the first receive window overlaps with the second receive window in terms of time, to ensure seamless transition without a blind area in detection in a target coverage area.

In an embodiment, the method further includes: receiving first indication information, where the first indication information indicates start time of the receive window of the sensing signal using the first parameter configuration and/or start time of a receive window of the sensing signal using the second parameter configuration.

In an embodiment, the receive window of the sensing signal using the first parameter configuration is the first receive window, and the receive window of the sensing signal using the second parameter configuration is the second receive window. The start time of the first receive window and/or the second receive window may be indicated by the first indication information. In this way, the start time of the first receive window and/or the second receive window can be accurately controlled.

In an embodiment, the first parameter configuration further includes at least one of a first guard period GP, a second GP, or a third GP, and the second parameter configuration further includes at least one of the first GP, the second GP, or the third GP, where the first GP is a GP between a sensing resource and a communication resource that are intra-frequency; the second GP is a GP between a sensing resource and a communication resource that are inter-frequency, or the second GP is a GP between a first sensing resource and a second sensing resource that are inter-frequency; and the third GP is a time interval between a transmit symbol of a sensing signal and start time of a corresponding receive window, and a length of the time interval is greater than a first threshold.

In an embodiment, the sensing resource is a resource for sensing and detection, and the communication resource is a resource for communication. For example, in vehicle-to-everything, a resource that is indicated by an access network device or another vehicle and that indicates navigation information is the communication resource, and a resource for detecting a surrounding vehicle is the sensing resource. The intra-frequency indicates that the two types of resources have the same frequency, and the inter-frequency indicates that the two types of resources have different frequencies. The first threshold is at least duration of the third GP. The third GP may be applied to a long-distance sensing scenario, for example, a satellite sensing scenario. The time interval between the transmit symbol and the start time of the receive window is large, and a resource in the time interval may be for transmission of another signal. In this way, a resource utilization rate can be improved.

In an embodiment, the method further includes: receiving second indication information, where the second indication information indicates the length of the time interval.

In an embodiment, the second indication information may indicate the time interval. This is beneficial to properly planning transmission of another sensing signal or communication signal.

In an embodiment, the first parameter configuration further includes a first repeated transmission interval, the second parameter configuration further includes a second repeated transmission interval, and the first repeated transmission interval is less than the second repeated transmission interval, where the first repeated transmission interval indicates a transmission interval of a sensing signal or channel using the first parameter configuration, and the second repeated transmission interval indicates a transmission interval of a sensing signal or channel using the second parameter configuration.

In an embodiment, because a repeated transmission interval may affect the maximum unambiguous range of sensing and detection, and may also affect accumulated energy in a time period, repeated transmission intervals of the two sets of parameter configurations are different, which is beneficial to measuring targets at different distances.

In an embodiment, the second repeated transmission interval is an integer multiple of the first repeated transmission interval.

In an embodiment, the second repeated transmission interval is the integer multiple of the first repeated transmission interval, so that the sensing signal using the first parameter configuration may be interleaved in the second repeated transmission interval for transmission, which is beneficial to improving the resource utilization rate. In addition, when the at least two sets of parameter configurations are used for sensing in a same frequency band, that the second repeated transmission interval is the integer multiple of the first repeated transmission interval is beneficial to staggering a resource that uses each set of parameter configurations for sensing, and avoiding a sensing conflict.

In an embodiment, the sensing signal determined based on the first parameter configuration is transmitted on a first beam, and the sensing signal determined based on the second parameter configuration is transmitted on a second beam; or the sensing signal determined based on the first parameter configuration and the sensing signal determined based on the second parameter configuration are transmitted on the first beam in a first time period, and transmitted on the second beam in a second time period, where the first time period and the second time period do not overlap with each other.

In an embodiment, sensing signals of different parameter configurations are transmitted on different beams, or sensing signals of two parameter configurations are transmitted on different beams in different time periods, so that targets at different distances in different directions can be sensed, and the sensing and detection range can be increased.

In an embodiment, the first parameter configuration further includes information about a time domain resource for sensing and information about a frequency domain resource for sensing. The information about the time domain resource indicates a time domain resource for transmission of a sensing signal, and the information about the frequency domain resource indicates a frequency domain resource for transmission of a sensing signal.

In an embodiment, the parameter configuration may further indicate the time domain resource and the frequency domain resource that are for sensing, which is beneficial to quickly determining a time-frequency resource for sensing, and then sending or receiving the sensing signal.

In an embodiment, the foregoing step of performing sensing based on the at least two sets of parameter configurations includes: performing sensing on a first frequency band based on the first parameter configuration; and performing sensing on a second frequency band based on the second parameter configuration.

In an embodiment, a sensing process may be performed in a plurality of frequency bands, and parameter configurations in different frequency bands may be different. In this way, different distances may be detected in different frequency bands.

In an embodiment, the foregoing step of performing sensing based on the at least two sets of parameter configurations includes: performing sensing on a first frequency band based on the at least two sets of parameters; and the method further includes: obtaining at least one set of parameter configurations for sensing on a second frequency band, where the at least one set of parameter configurations is included in the at least two sets of parameter configurations, or the at least one set of parameter configurations is different from the at least two sets of parameter configurations; and performing sensing on the second frequency band based on the at least one set of parameter configurations.

In an embodiment, value of parameters in the at least one set of parameter configurations may be different from or partially the same as values of parameters in the at least two sets of parameter configurations, provided that values of parameters in each of the at least one set of parameter configurations are not the same as values of parameters in each of the at least two sets of parameter configurations. The solution represents that one or more sets of parameter configurations may be for sensing in different frequency bands. In this way, targets at different distances may be measured in each frequency band.

In an embodiment, a third sensing signal transmitted on the first frequency band and a fourth sensing signal transmitted on the second frequency band are transmitted in a time division multiplexing manner, and a receive window of the third sensing signal overlaps with a receive window of the fourth sensing signal; or the receive window of the third sensing signal transmitted on the first frequency band overlaps with the receive window of the fourth sensing signal transmitted on the second frequency band, and sending time of the third sensing signal overlaps with sending time of the fourth sensing signal.

In an embodiment, during sensing in a plurality of frequency bands, the plurality of frequency bands may share one power amplifier (PA), or the plurality of frequency bands do not share one PA. When the PA is shared, the third sensing signal transmitted on the first frequency band and the fourth sensing signal transmitted on the second frequency band are transmitted in the time division multiplexing manner, and the receive window of the third sensing signal overlaps with the receive window of the fourth sensing signal. When the PA is not shared, the receive window of the third sensing signal transmitted on the first frequency band overlaps with the receive window of the fourth sensing signal transmitted on the second frequency band, and the sending time of the third sensing signal overlaps with the sending time of the fourth sensing signal. In this way, compared with a non-overlapping case, a sensing delay between transmission and reception can be reduced.

In an embodiment, the obtaining at least two sets of parameter configurations includes: receiving the at least two sets of parameter configurations through a target interface, where the target interface is a new radio positioning protocol (NRPP) or a long term evolution positioning protocol (LPP); the target interface is a Uu interface; or the target interface is a sidelink interface.

In an embodiment, the receiving the first parameter configuration and the second parameter configuration through a target interface includes: receiving the first parameter configuration and the second parameter configuration from a sensing management function unit through the target interface.

According to a second aspect of this application, a communication apparatus is provided. The communication apparatus includes a transceiver module and a processing module.

The transceiver module is configured to obtain at least two sets of parameter configurations, where the at least two sets of parameter configurations include a first parameter configuration for sensing and a second parameter configuration for sensing, the first parameter configuration includes a first subcarrier spacing SCS, the second parameter configuration includes a second SCS, and the first SCS is greater than the second SCS.

The processing module is configured to perform sensing based on the at least two sets of parameter configurations.

In an embodiment, the first SCS is a largest SCS in SCSs supported by at least one frequency band in an active state.

In an embodiment, the first SCS is one SCS in SCSs supported by a frequency band in an inactive state, and the one SCS supported by the frequency band in the inactive state is greater than an SCS supported by a frequency band in an active state.

In an embodiment, the first parameter configuration further includes a first cyclic prefix CP, the second parameter configuration further includes a second CP, the first CP corresponds to the first SCS, the second CP corresponds to the second SCS, and the first CP is less than the second CP.

In an embodiment, the first CP is a first product; and the first product is a product of a normal CP corresponding to the first SCS and α, and 0≤α<1.

In an embodiment, the second CP is a second product; and the second product is a product of a normal CP corresponding to the second SCS and β, or a product of a physical random access channel PRACH CP corresponding to the second SCS and β, and β>1.

In an embodiment, the first parameter configuration further includes a length of a first receive window; and the length of the first receive window is not less than a sum of a length of a first symbol and twice a length of the first CP, and the length of the first symbol is a reciprocal of the first SCS; or the length of the first receive window is N times the length of the first symbol, and N>1.

In an embodiment, the second parameter configuration further includes a length of a second receive window; and the length of the second receive window is not less than a sum of a length of a second symbol and twice a length of the second CP, and the length of the second symbol is a reciprocal of the second SCS; or the length of the second receive window is not less than a sum of twice the length of the second CP and a length of (M+1) second symbols, M is an integer, and M≥2.

In an embodiment, a length of a transmit symbol of a sensing signal obtained based on the second parameter configuration is not greater than the length of the first receive window, and the first receive window is a receive window of a sensing signal using the first parameter configuration.

In an embodiment, the transceiver module is further configured to receive first indication information, where the first indication information indicates start time of the receive window of the sensing signal using the first parameter configuration and/or start time of a receive window of the sensing signal using the second parameter configuration.

In an embodiment, the first parameter configuration further includes at least one of a first guard period GP, a second GP, or a third GP, and the second parameter configuration further includes at least one of the first GP, the second GP, or the third GP, where the first GP is a GP between a sensing resource and a communication resource that are intra-frequency; the second GP is a GP between a sensing resource and a communication resource that are inter-frequency, or the second GP is a GP between a first sensing resource and a second sensing resource that are inter-frequency; and the third GP is a time interval between a transmit symbol of a sensing signal and start time of a corresponding receive window, and a length of the time interval is greater than a first threshold.

In an embodiment, the transceiver module is further configured to receive second indication information, where the second indication information indicates the length of the time interval.

In an embodiment, a sensing resource of the first sensing signal in a time range of the third GP is for transmission of a communication signal or a channel, or the sensing resource of the first sensing signal in the time range of the third GP is for transmission of a second sensing signal or a channel.

In an embodiment, the first parameter configuration further includes a first repeated transmission interval, the second parameter configuration further includes a second repeated transmission interval, and the first repeated transmission interval is less than the second repeated transmission interval, where the first repeated transmission interval indicates a transmission interval of a sensing signal or channel using the first parameter configuration, and the second repeated transmission interval indicates a transmission interval of a sensing signal or channel using the second parameter configuration.

In an embodiment, the second repeated transmission interval is an integer multiple of the first repeated transmission interval.

In an embodiment, the sensing signal determined based on the first parameter configuration is transmitted on a first beam, and the sensing signal determined based on the second parameter configuration is transmitted on a second beam; or the sensing signal determined based on the first parameter configuration and the sensing signal determined based on the second parameter configuration are transmitted on the first beam in a first time period, and transmitted on the second beam in a second time period, where the first time period and the second time period do not overlap with each other.

In an embodiment, the first parameter configuration further includes information about a time domain resource for sensing and information about a frequency domain resource for sensing. The information about the time domain resource indicates a time domain resource for transmission of a sensing signal, and the information about the frequency domain resource indicates a frequency domain resource for transmission of a sensing signal.

In an embodiment, the processing module is configured to perform sensing on a first frequency band based on the first parameter configuration; and perform sensing on a second frequency band based on the second parameter configuration.

In an embodiment, the processing module is configured to perform sensing on a first frequency band based on the at least two sets of parameters.

The transceiver module is further configured to obtain at least one set of parameter configurations for sensing on a second frequency band, where the at least one set of parameter configurations is included in the at least two sets of parameter configurations, or the at least one set of parameter configurations is different from the at least two sets of parameter configurations.

The processing module is further configured to perform sensing on the second frequency band based on the at least one set of parameter configurations.

In an embodiment, a third sensing signal transmitted on the first frequency band and a fourth sensing signal transmitted on the second frequency band are transmitted in a time division multiplexing manner, and a receive window of the third sensing signal overlaps with a receive window of the fourth sensing signal; or the receive window of the third sensing signal transmitted on the first frequency band overlaps with the receive window of the fourth sensing signal transmitted on the second frequency band, and sending time of the third sensing signal overlaps with sending time of the fourth sensing signal.

In an embodiment, the transceiver module is configured to receive the at least two sets of parameter configurations through a target interface, where the target interface is NRPP or a long term evolution positioning protocol LPP; the target interface is a Uu interface; or the target interface is a sidelink interface.

In an embodiment, the transceiver module is configured to receive the first parameter configuration and the second parameter configuration from a sensing management function unit through the target interface.

According to a third aspect of this application, a communication apparatus is provided. The communication apparatus includes a processor. The processor is configured to invoke and run a computer program stored in a memory, to cause the processor to implement any one of the first aspect or the implementations of the first aspect.

In an embodiment, the communication apparatus further includes a transceiver. The processor is further configured to control the transceiver to receive/send a signal.

In an embodiment, the communication apparatus includes a memory. The memory stores the computer program.

The foregoing communication apparatus according to the third aspect may be a device or a chip (system) in the device.

According to a fourth aspect of this application, a communication apparatus is provided. The communication apparatus may be a first apparatus, a module or unit (for example, a chip, a chip system, or a circuit) that is in the first apparatus and that is in one to one correspondence with the method/operations/steps/actions described in the first aspect/the second aspect, or an apparatus that can be used in combination with the first apparatus.

According to a fifth aspect of this application, a computer program product including instructions is provided. When the instructions are run on a computer, the computer is caused to perform any one of the first aspect or the implementations of the first aspect.

According to a sixth aspect of this application, a computer-readable storage medium including computer instructions is provided. When the computer instructions are run on a computer, the computer is caused to perform any one of the first aspect or the implementations of the first aspect.

According to a seventh aspect of this application, a chip apparatus including a processor is provided. The processor is configured to be connected to a memory, and invoke a program stored in the memory, to cause the processor to perform any one of the first aspect or the implementations of the first aspect.

According to an eighth aspect of this application, a communication system is provided. The communication system includes a communication apparatus, and the communication apparatus is configured to perform any one of the first aspect or the implementations of the first aspect.

### BRIEF DESCRIPTION OF DRAWINGS

To describe technical solutions in embodiments of this application more clearly, the following briefly describes accompanying drawings for describing embodiments. It is clear that the accompanying drawings in the following descriptions show merely some embodiments of this application, and one of ordinary skilled in the art may still derive other accompanying drawings from these accompanying drawings without creative efforts.

FIG. 1A is a diagram of a structure of a communication system according to an embodiment of this application;

FIG. 1B is a diagram of another structure of a communication system according to an embodiment of this application;

FIG. 1C is a diagram of another structure of a communication system according to an embodiment of this application;

FIG. 2 is a diagram of an embodiment of a sensing method according to an embodiment of this application;

FIG. 3 is a diagram of a sensing example according to an embodiment of this application;

FIG. 4A to FIG. 4D are diagrams of several examples of a receive window according to an embodiment of this application;

FIG. 5A to FIG. 5D are diagrams of several examples of a guard period GP according to an embodiment of this application;

FIG. 6 is a diagram of repeated transmission intervals of sensing signals of different parameter configurations according to an embodiment of this application;

FIG. 7A and FIG. 7B are diagrams of combining a beam with a repeated transmission interval according to an embodiment of this application;

FIG. 8A and FIG. 8B are diagrams of a configuration related to a sidelink according to an embodiment of this application;

FIG. 9A to FIG. 9C are diagrams of several examples of transmission in a plurality of frequency bands according to an embodiment of this application;

FIG. 10A is a diagram of a structure of a communication apparatus according to an embodiment of this application;

FIG. 10B is a diagram of another structure of a communication apparatus according to an embodiment of this application; and

FIG. 11 is a diagram of another structure of a communication apparatus according to an embodiment of this application.

### DESCRIPTION OF EMBODIMENTS

Embodiments of this application provide a sensing method, to improve a sensing ranging range as much as possible. This application further provides a corresponding communication method, a communication apparatus, a computer-readable storage medium, and a computer program product. Details are separately described below.

The following clearly describes the technical solutions in embodiments of this application with reference to the accompanying drawings in embodiments of this application. It is clear that the described embodiments are merely some but not all of embodiments of this application. All other embodiments obtained by one of ordinary skilled in the art based on embodiments of this application without creative efforts shall fall within the protection scope of this application.

The technical solutions in embodiments of this application may be applied to various communication systems, such as a satellite communication system, a 5th generation (5G) system or new radio (NR), a long term evolution (LTE) system, an LTE frequency division duplex (FDD) system, an LTE time division duplex (TDD) system, a universal mobile telecommunications system (UMTS), a mobile communication system after a 5G network (for example, a 6G mobile communication system), vehicle-to-everything (vehicle-to-everything, V2X) communication system.

In addition to stronger communication capabilities, the foregoing communication systems may also have sensing capabilities, and are communication systems with integrated sensing and communication. The communication system with integrated sensing and communication mean that the communication system may perform communication by using a communication signal (the communication signal may alternatively be described as a communication channel), and may also perform sensing and measurement through a sensing signal (the sensing signal may alternatively be described as a sensing channel).

In this application, “sensing” is sensing a surrounding environment, detecting a target, and the like by using transmission, reflection, and scattering of radio waves. For example, in vehicle-to-everything (V2X), another vehicle or an object around a vehicle is sensed by using a sensing signal. Certainly, the communication system in this application may alternatively be a communication system that needs sensing, for example, an industrial automation system.

The communication system in this application may be a communication system based on orthogonal frequency division multiplexing (OFDM) and time division multiplexing (TDM).

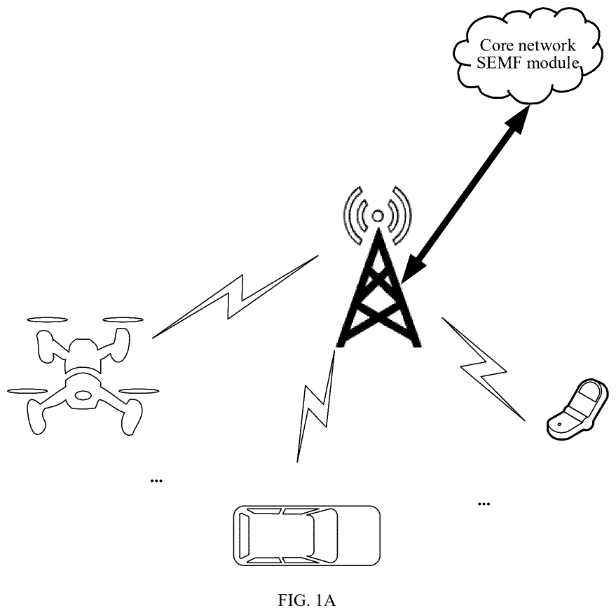

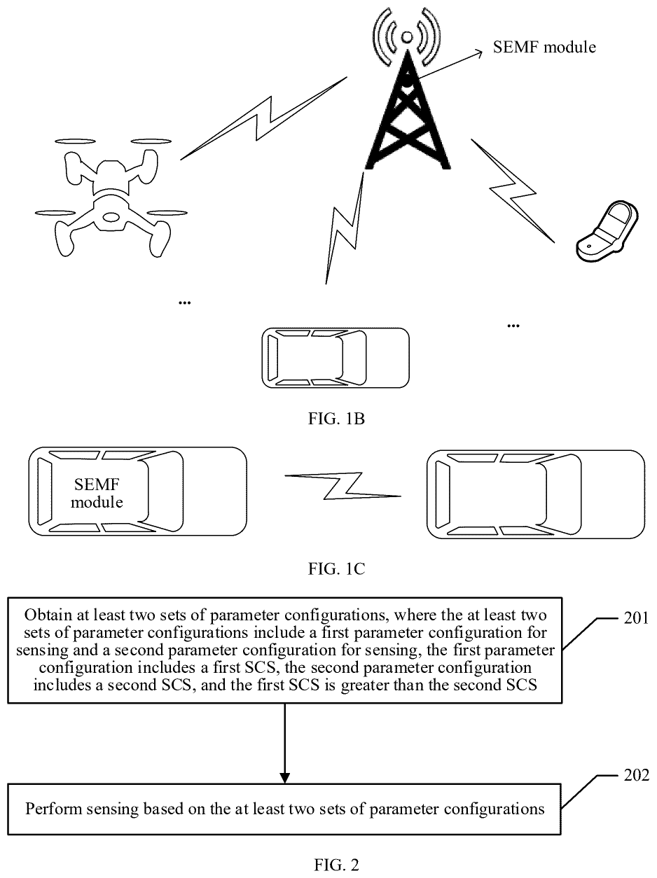

For the communication system provided in this application, refer to FIG. 1A to FIG. 1C for understanding.

As shown in FIG. 1A, a communication system shown in FIG. 1A includes a core network, an access network device, and a terminal device. The core network includes a sensing management function (SEMF) module. The SEMF module may be integrated in an existing device of the core network, or may be an independent device. The SEMF module may manage a parameter configuration for sensing, or may perform sensing and calculation based on a sensing and measurement result.

The SEMF module may send the parameter configuration for sensing to the access network device or the terminal device through a target interface. For example, the SEMF module may send the parameter configuration for sensing to the access network device through a new radio positioning protocol (NRPP), or send the parameter configuration for sensing to the terminal device through a long term evolution positioning protocol (LPP).

The access network device or the terminal device may perform sensing based on the received parameter configuration, to obtain a sensing result.

As shown in FIG. 1B, a communication system shown in FIG. 1B includes an access network device and a terminal device, and a SEMF module is integrated in the access network device. The access network device may send a parameter configuration to the terminal device through a Uu interface between the access network device and the terminal device. The terminal device may perform sensing based on the received parameter configuration, to obtain a sensing result.

As shown in FIG. 1C, a communication system shown in FIG. 1C includes a plurality of terminal devices (vehicles are used as an example in FIG. 1C), and a SEMF module may be integrated in a terminal device. The terminal device integrated with the SEMF module may send a parameter configuration to other terminal devices through a sidelink. The terminal devices may perform sensing based on the received parameter configuration, to obtain a sensing result.

The sensing result in this application may be for target identification, positioning, and the like. A process of processing the sensing result to implement target identification and positioning may be completed by a device that obtains the sensing result through measurement. Alternatively, the device that obtains the sensing result through measurement may send the corresponding sensing result to the SEMF module, and the SEMF module performs calculation based on the sensing result, to perform target identification, perform positioning, or the like.

The communication systems described in FIG. 1A to FIG. 1C each are configured with only one SEMF module. It should be noted that, a plurality of SEMF modules may be alternatively configured in the communication system. For example, in FIG. 1A, a SEMF module is configured in a device in the core network, and a SEMF module may also be configured in the access network device and/or the terminal device, or a dedicated device for configuring a SEMF module is deployed in the communication system. Only one of the SEMF modules may be started for sensing management, different SEMF modules may be started at different time for sensing management, or the SEMF module for sensing management is determined in another manner. For example, the device in the core network or the access network device determines the SEMF module for sensing management.

The following describes the terminal device and the access network device in this application.

The terminal device may be a wireless terminal device that can receive scheduling and indication information of the device in the core network or the access network device. The wireless terminal device may be a device that provides voice and/or data connectivity for a user, a handheld device having a wireless connection function, another processing device connected to a wireless modem, or a device having a sensing function.

The terminal device is also referred to as user equipment (UE), a mobile station (MS), a mobile terminal (MT), or the like, and is a device that includes a wireless communication function and/or a sensing function (providing voice/data connectivity for a user), for example, a handheld device having a wireless connection function or a vehicle-mounted device. Currently, some examples of the terminal device are as follows: a mobile phone, a tablet computer, a notebook computer, a palmtop computer, an unmanned aerial vehicle, a mobile internet device (MID), a wearable device, a virtual reality (VR) device, an augmented reality (AR) device, a wireless terminal in industrial control, a wireless terminal in vehicle-to-everything, a wireless terminal in self driving, a wireless terminal in remote medical surgery, a wireless terminal in a smart grid, a wireless terminal in transportation safety, a wireless terminal in a smart city, a wireless terminal in a smart home, and the like. For example, the wireless terminal in the vehicle to everything may be a vehicle-mounted device, an entire vehicle device, a vehicle-mounted module, a vehicle, or the like. The wireless terminal in industrial control may be a camera, a robot, or the like. The wireless terminal in the smart home may be a television, an air conditioner, a sweeper, a speaker, a set-top box, or the like.

The access network device is a device that is deployed in a radio access network and that provides a wireless communication function and/or a sensing function for the terminal device. For example, the access network device may be a radio access network (RAN) node that connects the terminal device to a wireless network.

The access network device includes, but is not limited to an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), an access point (AP) in wireless fidelity (Wi-Fi) system, a wireless relay node, a wireless backhaul node, a transmission point (TP), a transmission reception point (TRP), or the like. Alternatively, the access network device may be an access network device in a 5G mobile communication system, for example, a next generation NodeB (gNB), a transmission reception point (TRP), or a transmission point (TP) in a new radio (NR) system, or one or a group of (including a plurality of antenna panels) antenna panels of a base station in the 5G mobile communication system. Alternatively, the access network device may be a network node forming a gNB or a transmission point, for example, a baseband unit (BBU) or a distributed unit (distributed unit, DU).

In some deployments, the gNB may include a central unit (CU) and a DU. The gNB may further include an active antenna unit (active antenna unit, AAU). The CU implements some functions of the gNB, and the DU implements some functions of the gNB. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a medium access control (MAC) layer, and a physical (PHY) layer. The AAU implements some physical layer processing functions, radio frequency processing, and a function related to an active antenna. Information at an RRC layer is finally changed to information at the PHY layer, or is changed from the information at the PHY layer. Therefore, in this architecture, a higher layer signaling (for example, an RRC layer signaling) may also be considered to be sent by the DU, or sent by the DU and the AAU. It may be understood that, the access network device may be a device including one or more of a CU node, a DU node, and an AAU node. In addition, the CU may be classified as an access network device in the access network (RAN), or the CU may be classified as an access network device in the core network (CN). This is not limited in this application.

For ease of understanding embodiments of this application, the following first briefly describes several terms in this application.
1. Orthogonal frequency division multiplexing (OFDM): a type of multi-carrier modulation. The OFDM mainly divides a channel into several orthogonal subchannels, converts a high-speed data signal into parallel low-speed sub-data streams, and modulates the sub-data streams to each subchannel for transmission. An orthogonal signal may be separated by a receiving end by using a related technology, to reduce inter-subchannel interference (ISI). A signal bandwidth of each subchannel is less than a related bandwidth of the channel. Therefore, fading on each subchannel may be regarded as flat fading, to eliminate inter-symbol interference. In addition, because the bandwidth of each subchannel is only a small part of the original channel bandwidth, channel equalization becomes easy.
2. Time division multiplexing (TDM): a working mode in a communication system. A resource may be for different purposes at different time, for example, for sending a signal in a time period and for receiving a signal in another time period.
3. Carrier: a radio wave that has a frequency band and that is modulated to transmit a signal, or an electromagnetic wave of a bandwidth.
3. Subcarrier: is obtained by dividing a carrier of a bandwidth in an OFDM system.
4. Subcarrier spacing (SCS): a width of a subcarrier. The SCS is usually 15 kHz or a multiple of 15 kHz, where kHz is kilohertz.
5. Symbol length: a length of an OFDM symbol. The symbol length is usually a reciprocal of a subcarrier spacing. For example, a symbol length corresponding to an SCS of 15 kHz is 66.7 microseconds (μs).
6. Cyclic prefix (CP): is formed by copying a signal at the end of an OFDM symbol to the head of the OFDM symbol. There are two types of CPs in terms of length: a normal cyclic prefix (normal CP) and an extended cyclic prefix (extended CP). A length of the normal cyclic prefix is 4.7 μs, and a length of the extended cyclic prefix is 16.67 μs. The cyclic prefix may be associated with another multipath component information to obtain complete information. In addition, the cyclic prefix may implement time pre-estimation and frequency synchronization. In a physical random access channel (PRACH), there is also a PRACH CP, where the PRACH CP is usually greater than the normal CP.
7. Receive window (Rx window): a configured time length for receiving a return signal. The return signal is a multipath signal corresponding to a transmitted sensing signal, like a reflected signal or a diffracted signal.
8. Repeated transmission interval: a time interval between start time of two signals, or an interval between end time of a preceding signal and start time of a subsequent signal.
9. Frequency band: a frequency domain resource of a width. The frequency band may be a carrier, or may be a bandwidth part (BWP).
10. Beam: a communication resource. The beam may be a wide beam, a narrow beam, or another type of beam, and a technology for forming the beam may be a beamforming technology or another technical means. The beamforming technology may be a digital beamforming technology, an analog beamforming technology, and a hybrid digital/analog beamforming technology. Different beams may be considered as different resources. A beam for sending a signal may be referred to as a transmit beam (Tx beam), and a beam for receiving a signal may be referred to as a receive beam (Rx beam). The transmit beam may be signal strength distribution formed in different directions in space after a signal is transmitted through an antenna. The receive beam may be signal strength distribution, in different directions in space, of a radio signal received through an antenna.

The sensing method provided in embodiments of this application may be performed by the foregoing access network device or terminal device, or may be performed by a chip in the foregoing access network device or terminal device. The following describes the sensing method in this application with reference to the accompanying drawings.

As shown in FIG. 2, an embodiment of the sensing method provided in embodiments of this application includes the following operations:

201: Obtain at least two sets of parameter configurations, where the at least two sets of parameter configurations include a first parameter configuration for sensing and a second parameter configuration for sensing, the first parameter configuration includes a first SCS, the second parameter configuration includes a second SCS, and the first SCS is greater than the second SCS.

In this application, each set of parameter configurations may be understood as a sensing format. In this way, the at least two sets of parameter configurations are at least two sensing formats.

The first SCS and the second SCS each may be configured as 2^{u}*15 kHz, provided that a value of u when the first SCS is configured is greater than a value of u when the second SCS is configured. u may be a natural number, for example, 0, 1, 2, 3, 4, 5, 6, 7, 8, 9, or 10. Alternatively, the second SCS may be an SCS configured for a PRACH, for example, 1.25 kHz or 5 KHz.

202: Perform sensing based on the at least two sets of parameter configurations.

In an embodiment of the application, during sensing and detection, if sensing and detection need to cover a distance range as large as possible, it may be implemented by sensing a minimum distance as short as possible (to reduce a distance blind area), and sensing a maximum distance as long as possible (to increase a maximum unambiguous range) or reaching a target distance.

The minimum distance is restricted by a length of an OFDM symbol.

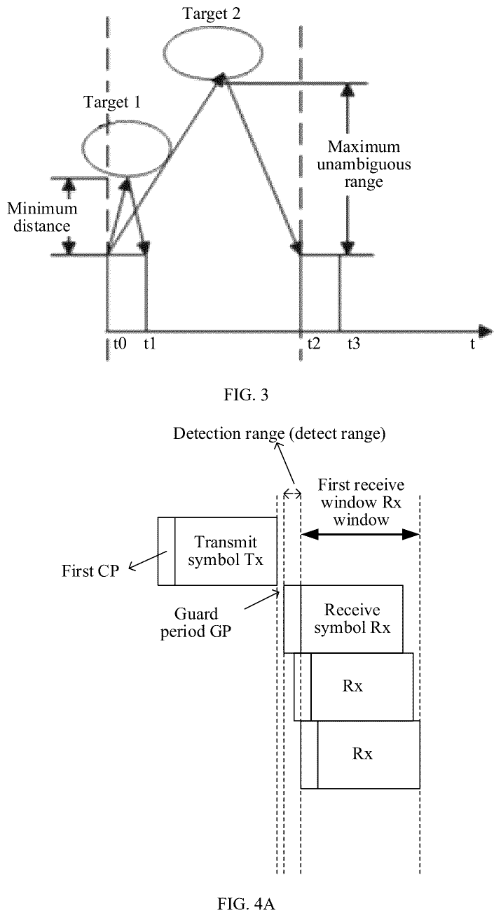

When a transmit antenna and a receive antenna are integrated (or are co-location), the transmit antenna and the receive antenna corresponds to a mono-static mode. To avoid self-interference of a sent sensing signal to a received return signal, a transceiver needs to start receiving after sending of the sensing signal is completed. Therefore, the return signal of the sensing signal can only come from a distance greater than 1/2*Tsym*c, where Tsym is a symbol length of the sensing signal, c is a speed of light, and the minimum distance may be a detection distance that is for a target 1 and that corresponds to t1−t0 as shown in FIG. 3, where to is start time of the sensing signal, and t1 is end time of the sensing signal.

When the transmit antenna and the receive antenna are separated, the transmit antenna and the receive antenna corresponds to a bistatic mode. The minimum distance is further restricted by a distance between the transmit antenna (Tx) and the receive antenna (Rx) and locations thereof. When the receive antenna simultaneously receives a sent sensing signal and a reflected sensing signal on a line-of sight path, interference of the sent signal to the received signal may be caused. For example, the return signal of the sensing signal can only come from a distance greater than 1/2*(Tsym*c+Dtxrx), where Dtxrx is the distance between the Tx antenna and the Rx antenna. In a calculation process, introduction of the distance Dtxrx between the Tx antenna and the Rx antenna may reduce interference of a line-of-sight path to the sent sensing signal and the received return signal. When sending and receiving are separated, the transmit antenna and the receive antenna may alternatively be located on two separated devices. Usually, in a beam-based transmission system, interference of a direct signal sent by the transmit antenna to a signal received by the receive antenna may be avoided through a beam direction.

The maximum distance is restricted by a maximum transmit power, signal duration, a channel condition, foreign interference, the target distance, and a maximum unambiguous range. Unambiguous ranging of adjacent-time sensing signals is usually determined by a distance corresponding to a time interval between sending time of the adjacent sensing signals. For the time interval, refer to t3−t0 in FIG. 3. The maximum unambiguous range sensed in the time interval is a distance of a target 2 in FIG. 3. A next sensing signal may be sent starting from t3.

In this application, in a case in which sending and receiving are integrated, a sensing and detection distance is restricted by the length of the OFDM symbol. Alternatively, it may be extended to that, in a case in which there is interference of the direct signal when sending and receiving are separated, the sensing and detection distance is also restricted by the length of the OFDM symbol, and the length of the OFDM symbol is usually a reciprocal of an SCS. Therefore, the SCS in the parameter configuration affects the sensing and detection distance.

In this application, sensing is performed by configuring the at least two sets of parameter configurations. In this way, there may be at least two SCSs, and sizes of the at least two SCSs are different. A larger first SCS corresponds to a shorter symbol length, to sense and detect a minimum distance as short as possible, and a smaller second SCS corresponds to a longer symbol length, to obtain higher symbol energy on a receiving side, and sense and detect a longer distance. In this way, a sensing and detection range is increased.

The foregoing first SCS is a largest SCS in SCSs supported by at least one frequency band in an active state, or the first SCS is one SCS in SCSs supported by a frequency band in an inactive state.

In an embodiment of the application, the SCS of the frequency band in the active state may be different from the SCS of the frequency band in the inactive state. Usually, the communication apparatus preferentially selects the largest SCS in the SCSs supported by the frequency band in the active state. If the largest SCS meets a sensing requirement, the largest SCS in the SCSs supported by the frequency band in the active state may be used as the first SCS. A larger first SCS indicates a smaller length of the OFDM symbol. In this way, the minimum distance as short as possible can be sensed, to reduce a distance blind area. The second SCS is less than the first SCS, and in a same quantity of transmission times, a longer OFDM symbol can bring higher receiving energy to support a longer sensing and detection distance, so that the second parameter configuration may be for sensing and detecting a long target distance, or may be for sensing and detecting the maximum distance (to increase the maximum unambiguous range). In this way, the sensing and detection range can be increased.

The foregoing first SCS is one SCS in SCSs supported by a frequency band in an inactive state, and the one SCS supported by the frequency band in the inactive state is greater than an SCS supported by a frequency band in an active state.

In an embodiment of the application, if a largest SCS in SCSs supported by the frequency band in the active state does not meet a sensing requirement, an SCS that is in the SCSs supported by the frequency band in the inactive state and that is greater than the SCS supported by the frequency band in the active state may be selected as the first SCS. In this way, the distance blind area may be reduced by using an SCS as large as possible.

In an embodiment of the application, a frequency band of a frequency range may correspond to a carrier or a bandwidth part; and may be located in a frequency band, or may be an entire frequency band supported by a sensing device, for example, FR1 (410 MHz to 7125 MHz) and FR2-1 (24250 MHz to 52600 MHz), or FR1, FR2-1, and FR2-2 (52600 MHz to 71000 MHz). When the frequency band in the inactive state is used, corresponding indication information may be sent by using signaling to indicate the frequency band in the inactive state.

In an embodiment of the application, in addition to the SCS, each set of parameter configurations may further include at least one of a CP, a receive window, start time of the receive window, a guard period (GP), a repeated transmission interval, a quantity of times of repeated transmission, a beam, information about a time domain resource, information about a frequency domain resource, and the like. The following separately describes functions of the parameters in a sensing process.

### I. CP:

The first parameter configuration further includes a first CP, the second parameter configuration further includes a second CP, the first CP corresponds to the first SCS, the second CP corresponds to the second SCS, and the first CP is less than the second CP.

### 1. First CP:

In the first parameter configuration, to detect a distance as short as possible, the length of the OFDM symbol may be reduced as much as possible. In this way, a length of the first CP also needs to be reduced as much as possible. The first CP may be 0. Usually, the first CP is configured as a first product; and the first product is a product of a normal CP corresponding to the first SCS and α, and 0≤α≤1. α may usually be a reciprocal of a natural number or 2⁽⁻ⁿ⁾, where n is a natural number.

A typical value of the normal CP is 144*K*2^{(-u)}+16*K*Tc, or 144*K*2^{(-u)}*Tc, where u corresponds to a parameter configuration of a subcarrier spacing, K=64, Tc=1/(480*103*4096), and a denominator of Tc corresponds to Hz.

In an embodiment of the application, the coefficient α may be configured by using signaling, and a SEMF module, an access network device, or a terminal device may configure the coefficient α for the sensing device by using the signaling.

In an embodiment of the application, the first CP can be adjusted more flexibly by configuring the coefficient α. In this way, the length of the OFDM symbol can be flexibly controlled by flexibly adjusting the first CP, so that targets with different distance detection requirements can be covered.

### 2. Second CP:

In the second parameter configuration, to support a longer sensing and detection distance, a length of the second CP may be increased, to suppress multipath interference of a reflected signal from a longer distance.

In an embodiment of the application, the second CP is a second product; and the second product is a product of a normal CP corresponding to the second SCS and β, or a product of a physical random access channel PRACH CP corresponding to the second SCS and β, and β>1.

β may be an integer greater than 0. Usually, β-2ⁿ, and n is a natural number. If only a maximum sensing and detection distance is considered to be supported, a length of the PRACH CP and a symbol length may be used as the sensing signal. The length of the PRACH CP is {288, 576, 864, 216, 360, 504, 936, 1240, 2048} *K*2^{(-u)}*Tc or {3168, 4688, 21024} *K*Tc. The symbol length corresponds to a length of 1, 2, 4, 6, or 8 OFDM symbols. For sensing and detection, a supported sensing distance range may be more flexible relative to a PRACH. When a minimum sensing and detection distance is considered to be supported, the symbol length may not be too large. In addition, considering that a multipath delay of the return signal of the sensing signal may be greater than the length of the second CP, a sum of the length of the PRACH CP and a common symbol length may alternatively be considered as a symbol of the sensing signal.

### II. Receive Window (Rx Window):

### 1. First Receive Window:

The first parameter configuration further includes a length of the first receive window; and the length of the first receive window is not less than a sum of a length of a first symbol and twice the length of the first CP, and the length of the first symbol is a reciprocal of the first SCS; or the length of the first receive window is N times the length of the first symbol, and N>1.

If a delay difference between arrival time of different multipath signals is in a range of the first CP, the length of the first receive window is not less than the sum of the length of the first symbol and twice the length of the first CP. In this way, a target of a multipath delay in the first CP can be sensed in duration of the first receive window.

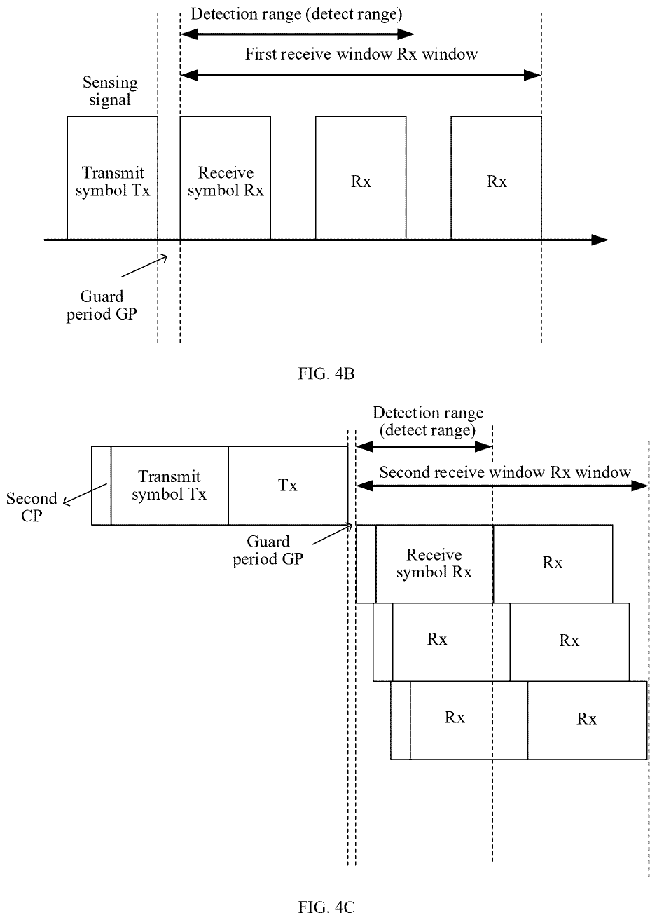

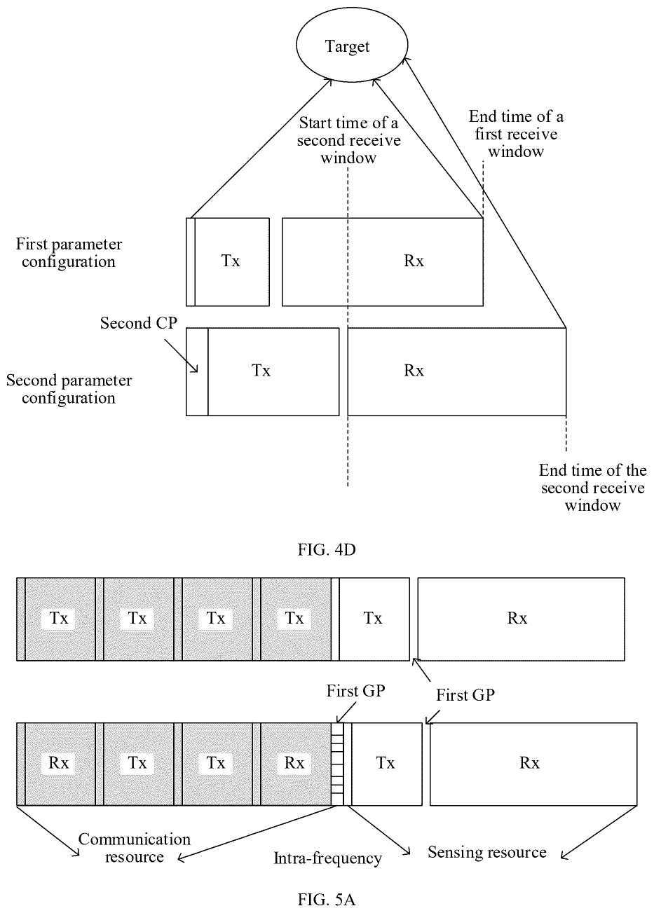

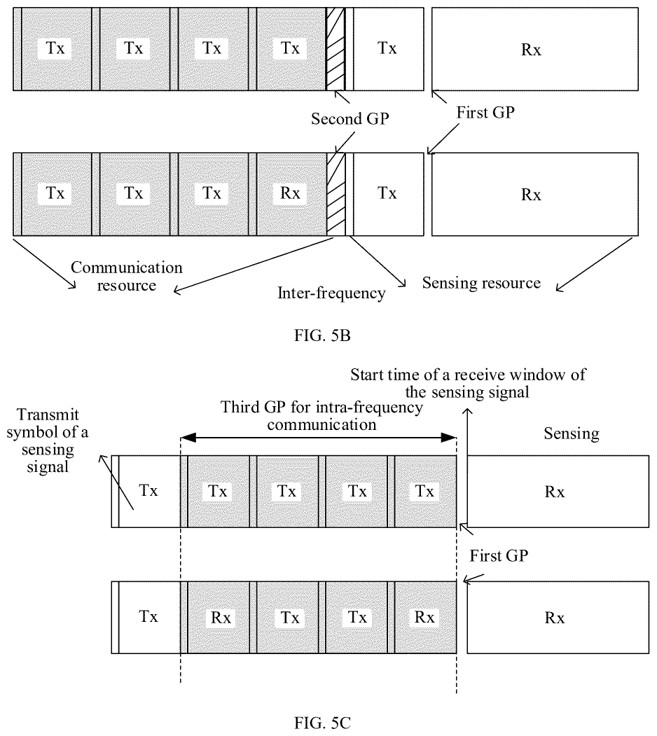

For this case, refer to FIG. 4A for understanding. As shown in FIG. 4A, in the length of the first receive window Rx window, a delay difference between arrival time of different return signals (multipath signals) corresponding to the sensing signal is in the range of the first CP. A length of a transmit symbol of the sensing signal is the same as a length of a receive symbol of the return signal. The foregoing first symbol may be the receive symbol, and both the sensing signal and the return signal use the first CP. A window length of the first Rx window is not less than a sum of the length of the receive symbol and twice the length of the first CP. In this way, the target of the multipath delay in the first CP, for example, a target in a detection range in FIG. 4A, may be sensed and detected in the first Rx window.

If the delay difference between the arrival time of the different multipath signals is greater than the length of the first symbol, and the multipath signals do not interfere with each other, the length of the first receive window may be N times the length of the first symbol. In this way, the longer sensing and detection distance can be supported.

For this case, refer to FIG. 4B for understanding. As shown in FIG. 4B, in a length of the second Rx window, the length of the transmit symbol of the sensing signal is the same as the length of the receive symbol of the return signal, and a delay difference between arrival time of different return signals is greater than the length of the receive symbol. For example, the length of the first Rx window needs to be greater than or equal to a multiple of the length of the receive symbol. In this way, a target at a longer distance, for example, a target in a detection range in FIG. 4B, may be supported in being detected.

### 2. Second Receive Window:

The second parameter configuration further includes the length of the second receive window; and the length of the second receive window is not less than a sum of a length of a second symbol and twice the length of the second CP, and the length of the second symbol is a reciprocal of the second SCS; or the length of the second receive window is not less than a sum of twice the length of the second CP and a length of (M+1) second symbols, M is an integer, and M≥2.

If the delay difference between the arrival time of the different multipath signals is in a range of the second CP, the length of the second receive window is not less than the sum of the length of the second symbol and twice the length of the second CP. In this way, a target of the multipath delay in the second CP can be sensed in duration of the second receive window.

In an embodiment of the application, if the delay difference between the arrival time of the different multipath signals is in the range of the second CP, for the length of the second receive window, refer to descriptions in FIG. 4A for understanding. If the length of the second receive window is not less than the sum of twice the length of the second CP and the length of the (M+1) second symbols, refer to FIG. 4C for understanding. The foregoing second symbol is a transmit symbol or a receive symbol in FIG. 4C. In FIG. 4C, the second CP and two repeated transmit symbols are used as the sensing signal. A distance that corresponds to the second CP in the second Rx window and a length of a 1^{st} receive symbol may be used as a maximum detection distance. When the receive symbol is repeated, the length of the second receive window is greater than or equal to a sum of lengths of a plurality of repeated receive symbols and the length of the second CP. As shown in FIG. 4C, the length of the second receive window is equal to a sum of the length of the second CP and lengths of three receive symbols. In FIG. 4C, a repeated transmit symbol in the sensing signal may alternatively be understood as an extended CP, and the original CP and a transmit symbol are used as the second CP. According to the configuration manner, the sensing and detection distance can be increased, and requirements for more different coverage distances can be met.

In addition, in an embodiment of the application, when the two sets of parameter configurations are used as complementary sensing configurations, to support a minimum sensing and detection distance and a proper maximum sensing and detection distance and ensure seamless transition without a blind area in sensing and detection in a target coverage area, a first receive window and a second receive window need to meet the following requirements: A length of a transmit symbol of a sensing signal obtained based on the second parameter configuration is not greater than the length of the first receive window, which is alternatively described as follows: By using respective start time of sensing signals of the two parameter configurations as a reference, start time of the second receive window of the sensing signal of the second parameter configuration is not later than end time of the first receive window of a sensing signal using the first parameter configuration. For a process of performing sensing by using the first parameter configuration and the second parameter configuration, refer to FIG. 4D for understanding.

As shown in FIG. 4D, the end time of the first receive window is end time of a receive symbol by using the first parameter configuration. The start time of the second receive window is start time of a receive symbol by using the second parameter configuration. By using the respective start time of the sensing signals of the two parameter configurations as a reference, the start time of the second receive window is after start time of the first receive window and before the end time of the first receive window.

In an embodiment of the application, for a relationship between the minimum sensing and detection distance and the target sensing and detection distance (the maximum unambiguous range), and the SCS, the CP, and the receive window, refer to Table 1.

TABLE 1
Relationship between the sensing and detection distance,
and the SCS, the CP, and the receive window

| | | | | | | Target | | Time length |
|---|---|---|---|---|---|---|---|---|
| | | Time T1 | Time T2 | Minimum | | sensing | | T1 + T2 (μs) |
| | | (μs) of a | (μs) of | sensing and | | and detection | | of the |
| | | single | dual | detection | | distance | | second |
| | SCS | symbol | symbols | distance | | (T2/2)*c + | | receive |
| u | (kHz) | with a CP | with CPs | (T2/2)*c | | T1*c | | window |
| 0 | 15 | 71.4 | 138 | 20.705 | km | 42.115 | km | 209.4 |
| 1 | 30 | 35.7 | 69 | 10.352 | km | 21.057 | km | 104.7 |
| 2 | 60 | 17.8 | 34.5 | 5.176 | m | 10.528 | km | 52.4 |
| 3 | 120 | 8.9 | 17.3 | 2.588 | km | 5.264 | km | 26.2 |
| 4 | 240 | 4.5 | 8.6 | 1.294 | km | 2.632 | km | 13.1 |
| 5 | 480 | 2.2 | 4.3 | 647 | m | 1.316 | km | 6.5 |
| 6 | 960 | 1.1 | 2.1 | 323 | m | 658 | m | 3.3 |
| 7 | 1920 | 0.6 | 1.1 | 162 | m | 329 | m | 1.6 |
| 8 | 3840 | 0.3 | 0.5 | 81 | m | 164 | m | 0.8 |
| 9 | 7680 | 0.1 | 0.3 | 40 | m | 82 | m | 0.4 |
| 10 | 15360 | 0.07 | 0.1 | 20 | m | 41 | m | 0.2 |

In the foregoing Table 1, a sensing signal having dual symbols with CPs is used as an example. Table 1 provides the time T1 of the single symbol with the CP, the time T2 of the dual symbols with the CPs, the time length of the second Rx window, the minimum sensing and detection distance, and the target sensing and detection distance based on the corresponding SCS and a corresponding length of the normal CP when the value of u is from 0 to 10. In this application, the time length of the second Rx window may be adjusted and configured based on a target coverage distance, or may be adapted based on an actual corresponding symbol quantity or a slot length. For example, an integer quantity of symbols is usually used as the time length of the second Rx window. Further, when a sensing format of repeated transmission is configured, because energy of a received return signal may be accumulated, the configured length of the second Rx window may be greater than the value shown in Table 1. The length of the second Rx window may be further configured with reference to a target sensing distance, a quantity of times of repeated transmission, and a delay range. The length of the second Rx window is generally greater than or equal to a sum of the length of the receive symbol and the length of the CP. When the receive symbol is repeated, the length of the second Rx window is greater than or equal to a sum of the length of the CP, the length of the 1^{st} receive symbol, and the length of the repeated receive symbol.

In an embodiment of the application, first indication information may be received, where first indication information indicates start time of the receive window of the sensing signal using the first parameter configuration and/or start time of a receive window of the sensing signal using the second parameter configuration. In this way, the start time of the first receive window and/or the second receive window can be accurately controlled.

### III. GP:

The first parameter configuration further includes at least one of a first GP, a second GP, or a third GP, and the second parameter configuration further includes at least one of the first GP, the second GP, or the third GP.

### 1. First GP:

The first GP is a GP between a sensing resource and a communication resource that are intra-frequency.

The sensing resource is a resource for sensing and detection, and the communication resource is a resource for communication. For example, in vehicle to everything, a resource that is indicated by an access network device or another vehicle and that indicates navigation information is the communication resource, and a resource for detecting a surrounding vehicle is the sensing resource. The intra-frequency indicates that the two types of resources, namely, the sensing resource and the communication resource, have the same frequency.

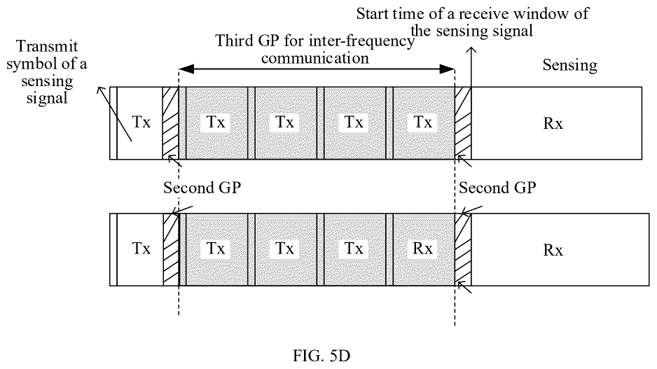

For the first GP, refer to FIG. 5A for understanding. As shown in FIG. 5A, one type of the first GP is a time interval between a transmit symbol and a receive symbol in the sensing resource, and another type of the first GP is a time interval between the transmit symbol of the sensing resource and a receive symbol of the communication resource. In FIG. 5A, the sensing resource and the communication resource have the same frequency. The first GP is usually a time for radio frequency conversion, and may be a time interval between receiving of a communication signal and sending of a sensing signal, a time interval between receiving of the sensing signal and sending of the communication signal, or a time interval between sending of the communication signal and sending of the sensing signal.

### 2. Second GP:

The second GP is a GP between a sensing resource and a communication resource that are inter-frequency, or the second GP is a GP between a first sensing resource and a second sensing resource that are inter-frequency. The inter-frequency indicates that the two types of resources, namely, the sensing resource and the communication resource, have different frequencies, or the first sensing resource and the second sensing resource have different frequencies.

For the second GP, refer to FIG. 5B for understanding. As shown in FIG. 5B, the second GP is time for inter-frequency handover. For example, when a communication signal uses a frequency band in an active state, and a sensing signal uses a frequency band in an inactive state, the communication resource and the sensing resource are resources of different frequencies. In this way, a time interval between sending of the communication signal and sending of the sensing signal, and a time interval between receiving of the communication signal and sending of the sensing signal each may be the second GP.

### 3. Third GP:

The third GP is a time interval between a transmit symbol of a sensing signal and start time of a corresponding receive window, and a length of the time interval is greater than a first threshold.

The first threshold is at least time of the third GP. The third GP may be applied to a long-distance sensing scenario.

For the third GP, refer to FIG. 5C and FIG. 5D for understanding. As shown in FIG. 5C and FIG. 5D, a time interval between the transmit symbol and a corresponding receive symbol of the sensing signal is large, for transmission of a communication signal or transmitting another sensing signal. A difference lies in that in FIG. 5C, a sensing resource of the sensing signal and a communication resource of an intermediate communication signal are intra-frequency resources, and in FIG. 5D, the sensing resource of the sensing signal and the communication resource of the intermediate communication signal are inter-frequency resources.

In FIG. 5C and FIG. 5D, it may alternatively be described as follows: A configurable length between the transmit symbol (Tx) and the receive symbol (Rx) of the sensing signal corresponding to the third GP may be for communication transmission or another sensing operation, end time of the third GP is the start time of the receive window of the sensing signal, and the start time of the receive window is configurable. The third GP is applicable to a scenario in which a target at a specified distance or in a specified distance range needs to be detected, and another scenario in which transmission time of the sensing signal is large, and a round-trip delay of reaching the target is far longer than time of a sensing symbol, for example, sensing and detection between satellites, or use of a large SCS. In this case, a distance corresponding to a symbol length of the sensing symbol is far smaller than a range of a detected target distance. In the two cases, time after the transmit symbol (Tx) may need to be configured as the start time of a receive time window. In this application, the time interval between the transmit symbol and the start time of the receive window is large, and a resource in the time interval may be for transmission of another signal. In this way, a resource utilization rate can be improved.

The time interval between the transmit symbol of the third GP and the start time of the corresponding receive window may be implemented in the following manner: receiving second indication information, where the second indication information indicates the length of the time interval. This is beneficial to properly planning transmission of another sensing signal or communication signal.

### IV. Repeated Transmission Interval, Quantity of Times of Repeated Transmission, and Beam:

1. Repeated transmission interval and quantity of times of repeated transmission:

In an embodiment of the application, the sensing signal may be periodically sent for sensing and detection, or may be for trigger/request-based aperiodic sensing and detection. Regardless of periodic sensing or aperiodic sensing, the sensing signal is usually sent for a plurality of times to accumulate energy, thereby increasing sensing coverage or improving measurement precision. Radio sensing performance may be described based on a sensing resolution, an unambiguous precision range, and sensing precision. Factors affecting the performance may be understood with reference to Table 2 to Table 4 below.

TABLE 2
Factors affecting the radio sensing resolution

| | |
|---|---|
| Distance resolution | c/(2B) |
| Velocity resolution | Lamda/(2M*Tr) |
| Angle resolution | 0.886*Lamda/D |

TABLE 3
Factors affecting the radio sensing unambiguous precision range

| | |
|---|---|
| Maximum unambiguous | c*Tr/2 |
| ranging range | |
| Unambiguous velocity | +Lamda/(4*Tr) or −Lamda/(4*Tr) |
| measurement range | |
| Unambiguous angle | +1/sin(Lamda/(2*d)) or −1/sin(Lamda/(2*d)) |
| measurement range | |

TABLE 4
Factors affecting the radio sensing precision

| | |
|---|---|
| Distance measurement precision | c/(2*B*sqrt(2*SNR)) |
| (root mean square variance) | |
| Velocity measurement precision | Lamda/(2*M*Tr*sqrt(2*SNR) |
| (root mean square variance) | |
| Angle measurement precision | theta/(1.6*sqrt(2*SNR) |
| (root mean square variance) | |

In the foregoing Table 2 to Table 4, c is the speed of light, B is a signal bandwidth, M is a quantity of repeated sensing signals or a quantity of repeated sensing formats (a quantity of times of repetition of different sets of parameter configurations) spaced apart by a receive window, Tr is a repetition periodicity or interval of the sensing signal, Lamda is a wavelength, D is an antenna array aperture, d is an antenna array element spacing, and theta represents a beam width. The (SNR) is a signal-to-noise ratio or a signal-to-interference-plus-noise ratio.

The radio sensing resolution indicates a closest degree between two adjacent targets that can be distinguished by a system. A smaller value of the radio sensing resolution indicates easier differentiation.

A radio sensing unambiguous range indicates that no confusion or unclearness occurs in the range. For example, for measurement of a same target, no more than one measurement quantity occurs. A larger unambiguous range is more beneficial to target identification.

The radio sensing precision indicates an error between a measurement value and an actual value, which is usually represented by a root mean square error. A small error indicates better performance.

Based on the foregoing three tables of Table 2 to Table 4, it can be obtained that the following conflicts exist in the repetition interval Tr of the sensing signal:
Increasing a pulse interval of the sensing symbol is beneficial to increasing the maximum unambiguous ranging range, improving the velocity resolution, and reducing overheads, but leads to a reduction of the unambiguous velocity measurement range.

Reducing the pulse interval of the sensing symbol reduces the maximum unambiguous ranging range, and reduces the velocity resolution, but is beneficial to improving the unambiguous velocity measurement range. In addition, reducing the pulse interval and increasing a quantity of times of repeated transmission are beneficial to improving the SNR, thereby improving the precision of ranging and velocity measurement.

In consideration of the foregoing points, according to an embodiment of the application, the at least two sets of parameter configurations that are complementary are configured, and respectively correspond to different sensing signal spacings. The first parameter configuration further includes a first repeated transmission interval, the second parameter configuration further includes a second repeated transmission interval, and the first repeated transmission interval is less than the second repeated transmission interval, where the first repeated transmission interval indicates a transmission interval of a sensing signal or channel using the first parameter configuration, and the second repeated transmission interval indicates a transmission interval of a sensing signal or channel using the second parameter configuration. Repeated transmission intervals of the two sets of parameter configurations are different, which is beneficial to measuring targets at different distances.

For example, for a large SCS parameter of the first parameter configuration (which can cover a shortest distance), a reduced repeated transmission interval 1 and/or a reduced quantity 1 of times of repetition of the sensing signal are/is configured; and for a small SCS parameter of the second parameter configuration (which can cover a long distance), an increased repeated transmission interval 2 and/or an increased quantity 2 of times of repetition of the sensing signal are/is configured. The first parameter configuration and the second parameter configuration may be respectively configured, or may be configured in a combination.

For the repeated transmission interval and the quantity of times of repeated transmission, refer to Table 5 for understanding.

TABLE 5
Retransmission transmission interval and quantity
of times of repeated transmission

| | First parameter | Second parameter |
|---|---|---|
| | configuration | configuration |
| Combination 1 | T11, R11 | T21, R21 |
| Combination 2 | T12, R12 | T22, R22 |
| Combination 3 | T13, R13 | T23, R23 |
| Combination 4 | T14, R14 | T24, R24 |

In Table 5, T11 represents the repeated transmission interval of the first parameter configuration in the combination 1, R11 represents the quantity of times of repeated transmission of the first parameter configuration in the combination 1, T21 represents the repeated transmission interval of the second parameter configuration in the combination 1, and R21 represents the quantity of times of repeated transmission of the second parameter configuration in the combination 1. Similarly, T12 and R12 respectively represent the repeated transmission interval and the quantity of times of repeated transmission of the first parameter configuration in the combination 2, T22 and R22 respectively represent the repeated transmission interval and the quantity of times of repeated transmission of the second parameter configuration in the combination 2; T13 and R13 respectively represent the repeated transmission interval and the quantity of times of repeated transmission of the first parameter configuration in the combination 3, and T23 and R23 respectively represent the repeated transmission interval and the quantity of times of repeated transmission of the second parameter configuration in the combination 3; and T14 and R14 respectively represent the repeated transmission interval and the quantity of times of repeated transmission of the first parameter configuration in the combination 4, and T24 and R24 respectively represent the repeated transmission interval and the quantity of times of repeated transmission of the second parameter configuration in the combination 4.

In an embodiment of the application, the second repeated transmission interval may be an integer multiple of the first repeated transmission interval. In this way, the sensing signal using the first parameter configuration may be interleaved in the second repeated transmission interval for transmission, which is beneficial to improving the resource utilization rate.

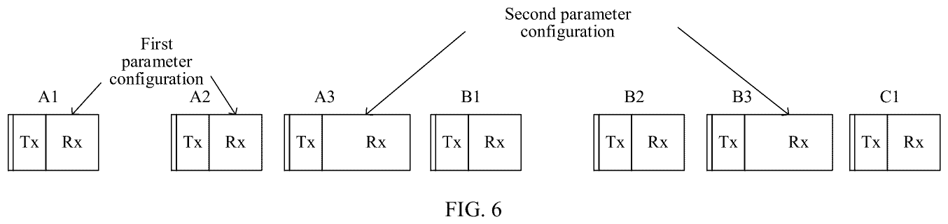

For the case in which the second repeated transmission interval is the integer multiple of the first repeated transmission interval, refer to FIG. 6 for understanding. As shown in FIG. 6, A1, A2, B1, B2, and C1 are sensing signals generated by using the first parameter configuration, and A3 and B3 are sensing signals generated by using the second parameter configuration. An interval between A1 and A2, an interval between A2 and B1, an interval between B1 and B2, and an interval between B2 and C1 each are the first repeated transmission interval, and an interval between A3 and B3 is the second repeated transmission interval. It can be learned from FIG. 6 that, B1 and B2 are further transmitted between A3 and B3, that is, the second repeated transmission interval may include the first repeated transmission interval. In addition, it can be further learned from FIG. 6 that, a quantity of times of repeated transmission of the sensing signal generated by using the first parameter configuration is greater than that of the sensing signal generated by using the second parameter configuration, and one sensing signal generated by using the second parameter configuration is transmitted only when two sensing signals generated by using the first parameter configuration are transmitted.

### 2. Repeated Transmission Interval+Beam;

In an embodiment of the application, a combination manner of the repeated transmission interval and the beam may be as follows:

2.1. The sensing signal determined based on the first parameter configuration is transmitted on a first beam, and the sensing signal determined based on the second parameter configuration is transmitted on a second beam.

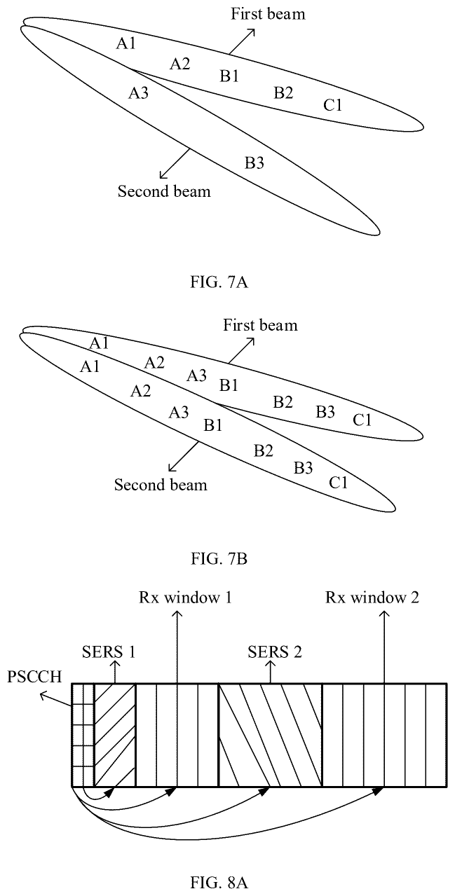

For the combination manner, refer to FIG. 7A for understanding. As shown in FIG. 7A, the sensing signals A1, A2, A3, B1, B2, B3, and C1 in FIG. 6 are still used as an example. FIG. 7A includes the first beam and the second beam. The sensing signals A1, A2, B1, B2, and C1 generated by using the first parameter configuration are transmitted on the first beam, and the sensing signals A3 and B3 generated by using the second parameter configuration are transmitted on the second beam.

2.2. The sensing signal determined based on the first parameter configuration and the sensing signal determined based on the second parameter configuration are transmitted on the first beam in a first time period, and transmitted on the second beam in a second time period, where the first time period and the second time period do not overlap with each other.

For the combination manner, refer to FIG. 7B for understanding. As shown in FIG. 7B, the sensing signals A1, A2, A3, B1, B2, B3, and C1 in FIG. 6 are still used as an example. FIG. 7B includes the first beam and the second beam. The sensing signals A1, A2, B1, B2, and C1 generated by using the first parameter configuration and the sensing signals A3 and B3 generated by using the second parameter configuration are transmitted on the first beam in the first time period. The sensing signals A1, A2, B1, B2, and C1 generated by using the first parameter configuration and the sensing signals A3 and B3 generated by using the second parameter configuration are transmitted on the second beam in the second time period. In this way, sensing signals of different parameter configurations are transmitted on different beams, or sensing signals of two parameter configurations are transmitted on different beams in different time periods, so that targets at different distances in different directions can be sensed, and the sensing and detection range can be increased.

### V. Time Domain Resource and Frequency Domain Resource:

In an embodiment of the application, the first parameter configuration further includes information about a time domain resource for sensing and information about a frequency domain resource for sensing. The information about the time domain resource indicates a time domain resource for transmission of a sensing signal, and the information about the frequency domain resource indicates a frequency domain resource for transmission of a sensing signal. In this application, the parameter configuration may further indicate the time domain resource and the frequency domain resource that are for sensing, which is beneficial to quickly determining a time-frequency resource for sensing.

In an embodiment of the application, a time-frequency resource configuration of the sensing signal of the access network device or the terminal device may be from a SEMF configuration. For the time domain resource, a time offset value of transmission start time of the sensing signal relative to frame start time may be configured. The frame start time may be a frame 0, or may be a specified frame number.

The frequency domain resource of the sensing signal is determined according to a bandwidth requirement of the sensing signal, for example, a sensing precision requirement.

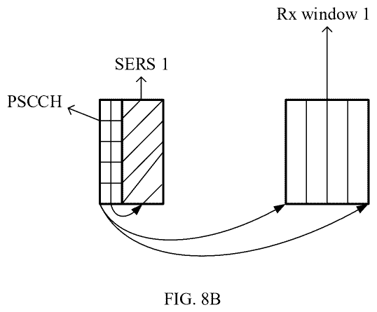

In addition, for a sidelink, a transmission resource of the sensing signal may be indicated by sidelink control information (SCI), as shown in FIG. 8A and FIG. 8B below. In FIG. 8A, SCI carried in a physical sidelink control channel (PSCCH) indicates a time-frequency resource of a sensing signal SERS 1 and a time range of an Rx window 1 corresponding to the sensing signal SERS 1, and a time-frequency resource of a sensing signal SERS 2 and a time range of an Rx window 2 corresponding to the sensing signal SERS 2. In FIG. 8B, the SCI of the PSCCH indicates the time-frequency resource of the sensing signal SERS 1, start time of the corresponding Rx window 1, and a length of a time window. In a case of contention-based sidelink resource allocation, indication information of the SCI of the PSCCH is obtained, to avoid that an adjacent terminal device uses a configured resource of the terminal device, thereby avoiding mutual interference.

The foregoing process of performing sensing based on the at least two sets of parameter configurations may be completed in one frequency band, or may be completed in two or more frequency bands. The following uses a first frequency band and a second frequency band as an example for description in a case of a plurality of frequency bands. Sensing in the plurality of frequency bands may alternatively be understood as multi-carrier sensing.

In the foregoing sensing process, different frequency bands may use a frequency division multiplexing (FDM) manner, and each frequency band still uses a TDM manner.

1. Perform sensing on the first frequency band based on the first parameter configuration; and perform sensing on the second frequency band based on the second parameter configuration.

In this case, the sensing process may be performed in a plurality of frequency bands, and parameter configurations in different frequency bands may be different. In this way, different distances may be detected in different frequency bands.

2. Obtain at least one set of parameter configurations for sensing on the second frequency band, where the at least one set of parameter configurations is included in the at least two sets of parameter configurations, or the at least one set of parameter configurations is different from the at least two sets of parameter configurations; and performing sensing on the second frequency band based on the at least one set of parameter configurations.

In this case, one or more sets of parameter configurations may be for sensing in different frequency bands. In this way, targets at different distances may be measured in each frequency band.

The case of sensing in the plurality of frequency bands may include that the plurality of frequency bands share one power amplifier (PA), or the plurality of frequency bands do not share one PA.

### 1. Share the PA:

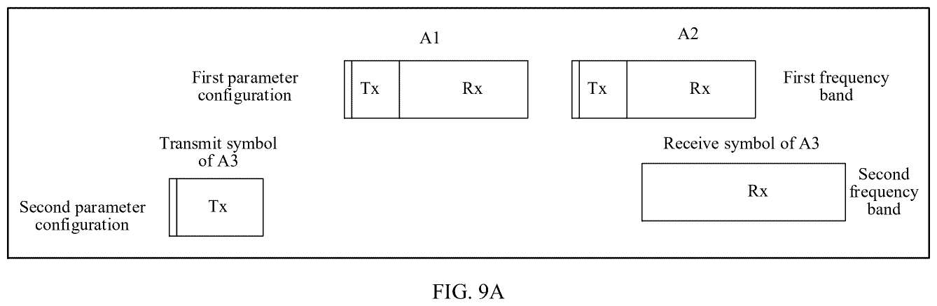

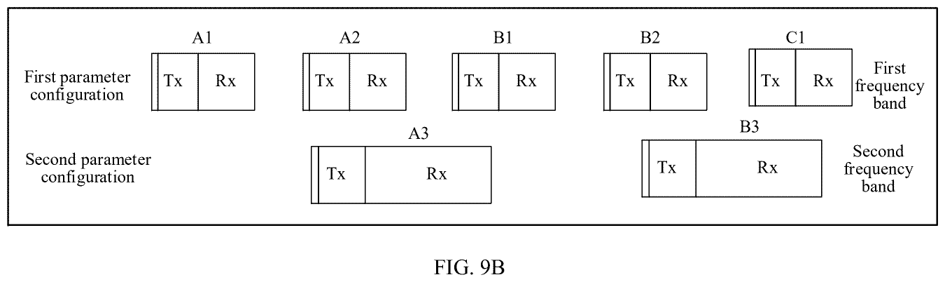

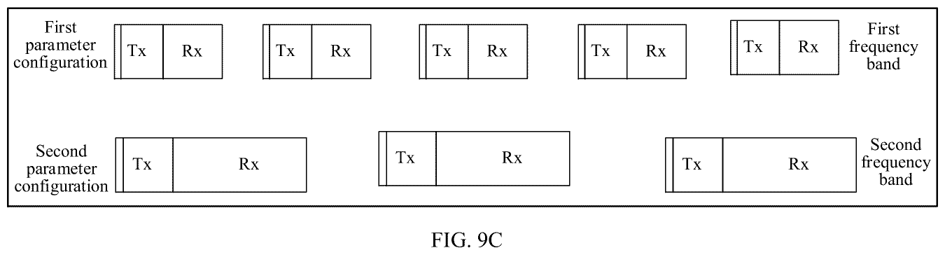

When the PA is shared, a third sensing signal transmitted on the first frequency band and a fourth sensing signal transmitted on the second frequency band are transmitted in the time division multiplexing manner, and a receive window of the third sensing signal overlaps with a receive window of the fourth sensing signal. For this case, refer to FIG. 9A for understanding. As shown in FIG. 9A, third sensing signals A1 and A2 generated by using the first parameter configuration are sent or received on the first frequency band, and a fourth sensing signal A3 generated by using the second parameter configuration is sent or received on the second frequency band. In the time division multiplexing manner, after a transmit symbol of A3 is first sent on the second frequency band, a transmit symbol of A1 may be sent on the first frequency band, and a receive symbol of A1 is received; then, a transmit symbol of A2 is sent on the first frequency band, and a receive symbol of A2 is received. A receive symbol (that is, a receive window) of A3 on the second frequency band overlaps with the receive symbol (that is, a receive window) of A2 on the first frequency band. In this case, because the PA is shared, to prevent a power from being restricted when the sensing signal is sent, sending time of the third sensing signal and sending time of the fourth sensing signal do not overlap with each other. In addition, because a power of a receiving process may not be restricted, and receiving frequencies may be orthogonal, the receive window of the third sensing signal and the receive window of the fourth sensing signal may overlap with each other.

Further, a repeated transmission interval of fourth sensing signals A3 and B3 that are located on the second frequency band and that are generated by using the second parameter configuration may include repeated transmission intervals of third sensing signals A1, A2, B1, B2, and C1 that are generated on the first frequency band and that are generated by using the first parameter configuration. In the case of the plurality of frequency bands, refer to the retransmission transmission interval and the quantity of times of repeated transmission described above. In the first parameter configuration, frequencies of different frequency bands, the retransmission transmission interval, and the quantity of times of repeated transmission may be combined, for example, (f1, repeated transmission interval, quantity of times of repeated transmission {T1, R1}) (f2, repeated transmission interval, quantity of times of repeated transmission {T2, R2}), where f1 represents the first frequency band, and f2 represents the second frequency band. As shown in FIG. 9B, a repeated transmission interval of the fourth sensing signals A3 and B3 transmitted on the second frequency band may be an integer multiple of a repeated transmission interval of A1, A2, B1, B2, and C1 transmitted on the first frequency band. In this configuration manner, time-frequency resources can be effectively used.

### 2. Do not Share the PA:

When the PA is not shared, the receive window of the third sensing signal transmitted on the first frequency band overlaps with the receive window of the fourth sensing signal transmitted on the second frequency band, and the sending time of the third sensing signal overlaps with the sending time of the fourth sensing signal.

When the PA is not shared, the sensing signals transmitted on the first frequency band and the second frequency band are not restricted by a power. Therefore, the sending time of the third sensing signal on the first frequency band and the sending time of the fourth sensing signal on the second frequency band may overlap with each other, and the receive windows thereof may also overlap with each other. As shown in FIG. 9C, Tx and Rx on the first frequency band and the second frequency band each may overlap with each other, and certainly, may not overlap with each other. The repeated transmission interval and the quantity of times of repeated transmission on the first frequency band and the second frequency band may be independently configured.

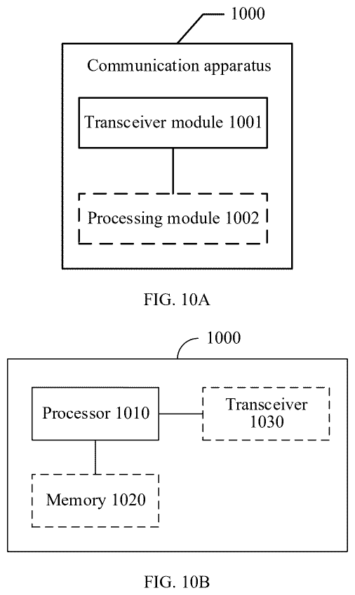

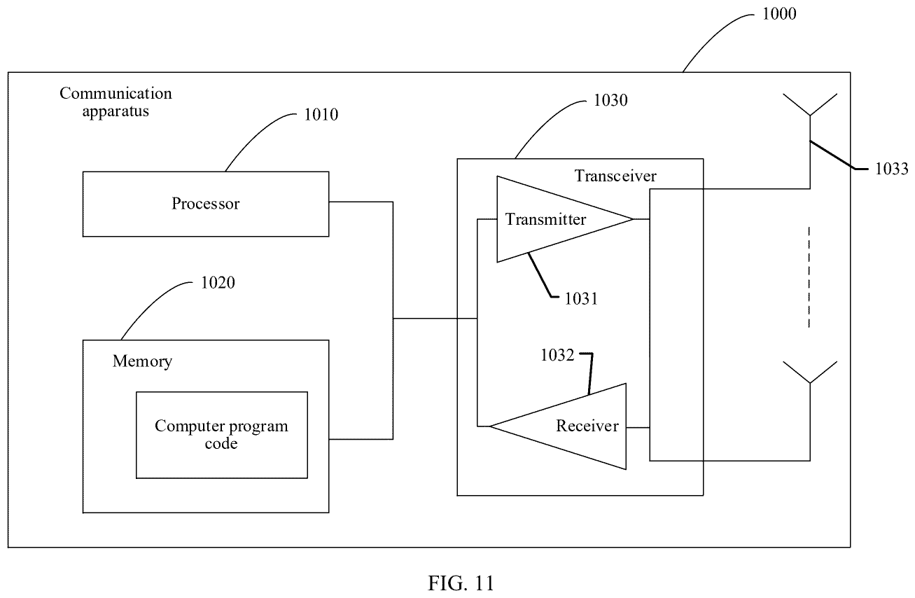

The foregoing describes the communication system and the sensing method in embodiments of this application. The following describes a communication apparatus provided in embodiments of this application. Refer to FIG. 10A. FIG. 10A is a diagram of a structure of a communication apparatus according to an embodiment of this application. A communication apparatus 1000 may be configured to perform operations in the embodiments shown in FIG. 2 to FIG. 9C. For details, refer to the related descriptions in the foregoing method embodiment.

The communication apparatus 1000 includes a transceiver module 1001 and a processing module 1002. The transceiver module 1001 may implement a corresponding communication function. The processing module 1002 is configured to process data. The transceiver module 1001 may also be referred to as a communication interface or a communication unit.

In an embodiment, the communication apparatus 1000 may further include a storage unit. The storage unit may be configured to store instructions and/or data. The processing module 1002 may read the instructions and/or the data in the storage unit, so that the communication apparatus implements the foregoing method embodiment.

The communication apparatus 1000 may be configured to perform actions in the foregoing method embodiment. The communication apparatus 1000 may be a terminal device/access network device, or may be a component that can be arranged in the terminal device/access network device. The transceiver module 1001 is configured to perform a receiving-related operation in the foregoing method embodiment, and the processing module 1002 is configured to perform a processing-related operation in the foregoing method embodiment.

In an embodiment, the transceiver module 1001 may include a sending module and a receiving module. The sending module is configured to perform a sending operation in the foregoing method embodiment. The receiving module is configured to perform a receiving operation in the foregoing method embodiment.

It should be noted that, the communication apparatus 1000 may include the sending module but not include the receiving module. Alternatively, the communication apparatus 1000 may include the receiving module but not include the sending module. This may be determined depending on whether the foregoing solutions performed by the communication apparatus 1000 include a sending action and a receiving action.

In an example, the communication apparatus 1000 is configured to perform actions in the embodiment shown in FIG. 2.

The transceiver module 1001 is configured to obtain at least two sets of parameter configurations, where the at least two sets of parameter configurations include a first parameter configuration for sensing and a second parameter configuration for sensing, the first parameter configuration includes a first subcarrier spacing SCS, the second parameter configuration includes a second SCS, and the first SCS is greater than the second SCS.

The processing module 1002 is configured to perform sensing based on the at least two sets of parameter configurations.

It should be understood that, processes in which the modules perform the foregoing corresponding steps are described in detail in the foregoing method embodiment. For brevity, details are not described herein again.

The processing module 1002 in the foregoing embodiment may be implemented by at least one processor or processor-related circuit. The transceiver module 1001 may be implemented by a transceiver or a transceiver-related circuit. The transceiver module 1001 may also be referred to as a communication unit or a communication interface. The storage unit may be implemented by at least one memory.

An embodiment of this application further provides another communication apparatus 1000. As shown in FIG. 10B, the communication apparatus 1000 includes a processor 1010. The processor 1010 is coupled to a memory 1020. The memory 1020 is configured to store a computer program or instructions and/or data. The processor 1010 is configured to execute the computer program or the instructions and/or the data stored in the memory 1020, so that the method in the foregoing method embodiment is performed.

In an embodiment, the communication apparatus 1000 includes one or more processors 1010.

In an embodiment, as shown in FIG. 10B, the communication apparatus 1000 may further include the memory 1020.

In an embodiment, the communication apparatus 1000 may include one or more memories 1020.

In an embodiment, the memory 1020 and the processor 1010 may be integrated together or separately arranged.

In an embodiment, as shown in FIG. 10B, the communication apparatus 1000 may further include a transceiver 1030. The transceiver 1030 is configured to receive and/or send a signal. For example, the processor 1010 is configured to control the transceiver 1030 to receive and/or send a signal.

In a solution, the communication apparatus 1000 is configured to implement operations in the foregoing method embodiment.

For example, the processor 1010 is configured to implement a processing-related operation in the foregoing method embodiment, and the transceiver 1030 is configured to implement a receiving/sending-related operation in the foregoing method embodiment.

An embodiment of this application further provides a communication apparatus 1000. The communication apparatus 1000 may be a terminal device/access network device, or may be a chip in the terminal device/access network device. The communication apparatus 1000 may be configured to perform operations in the foregoing method embodiment.

When the communication apparatus 1000 is a communication apparatus, FIG. 11 is a diagram of a simplified structure of the communication apparatus. As shown in FIG. 11, the communication apparatus includes a processor, a memory, and a transceiver. The memory may store computer program code. The transceiver includes a transmitter 1031, a receiver 1032, a radio frequency circuit (not shown in the figure), an antenna 1033, and an input/output apparatus (not shown in the figure). The processor is mainly configured to process a communication protocol and communication data, and control the communication apparatus to execute a software program, process data of the software program, and the like. The memory is mainly configured to store the software program and data. The radio frequency circuit is mainly configured to perform conversion between a baseband signal and a radio frequency signal, and process the radio frequency signal. The antenna is mainly configured to receive/send a radio frequency signal in a form of an electromagnetic wave. The input/output apparatus like a touchscreen, a display, or a keyboard, is mainly configured to receive data input by a user and output data to the user. It should be noted that, some communication apparatuses may not have the input/output apparatus.

When data needs to be sent, after performing baseband processing on the to-be-sent data, the processor outputs a baseband signal to the radio frequency circuit; and the radio frequency circuit performs radio frequency processing on the baseband signal and then sends the radio frequency signal to the outside in a form of an electromagnetic wave through the antenna. When data is sent to the communication apparatus, the radio frequency circuit receives a radio frequency signal through the antenna, converts the radio frequency signal into a baseband signal, and outputs the baseband signal to the processor. The processor converts the baseband signal into data, and processes the data. For ease of description, FIG. 11 shows only one memory, one processor, and one transceiver. In an actual communication apparatus product, there may be one or more processors and one or more memories. The memory may also be referred to as a storage medium, a storage device, or the like. The memory may be arranged independent of the processor, or may be integrated with the processor. This is not limited in embodiments of this application.

In an embodiment of the application, the antenna having the receiving/sending function and the radio frequency circuit may be considered as a transceiver unit of the communication apparatus, and the processor having the processing function may be considered as a processing unit of the communication apparatus.

As shown in FIG. 11, the communication apparatus includes a processor 1010, a memory 1020, and a transceiver 1030. The processor 1010 may also be referred to as a processing unit, a processing board, a processing module, a processing apparatus, or the like. The transceiver 1030 may also be referred to as a transceiver unit, a transceiver machine, a transceiver apparatus, or the like.

In an embodiment, a component that is in the transceiver 1030 and that is configured to implement a receiving function may be considered as a receiving unit, and a component that is in the transceiver 1030 and that is configured to implement a sending function may be considered as a sending unit. In other words, the transceiver 1030 includes a receiver machine and a transmitter machine. The transceiver sometimes may also be referred to as a transceiver machine, a transceiver unit, a transceiver circuit, or the like. The receiver machine sometimes may also be referred to as a receiver, a receiving unit, a receiving circuit, or the like. The transmitter machine sometimes may also be referred to as a transmitter, a transmit unit, a transmit circuit, or the like.

For example, in an embodiment, the processor 1010 is configured to perform a processing action in the embodiment shown in FIG. 2, and the transceiver 1030 is configured to perform a receiving/sending action in FIG. 2. For example, the transceiver 1030 is configured to perform a receiving/sending operation in step 201 in the embodiment shown in FIG. 2. The processor 1010 is configured to perform a processing operation in step 202 in the embodiment shown in FIG. 2.

It should be understood that, FIG. 11 is merely an example rather than a limitation. The foregoing communication apparatus including the transceiver unit and the processing unit may not depend on the structure shown in FIG. 11.

When the communication apparatus 1000 is a chip, the chip includes a processor, a memory, and a transceiver. The transceiver may be an input/output circuit or a communication interface. The processor may be a processing unit, a microprocessor, or an integrated circuit integrated on the chip. The sending operation performed by the communication apparatus in the foregoing method embodiment may be understood as an output of the chip, and the receiving operation performed by the communication apparatus in the foregoing method embodiment may be understood as an input of the chip.

An embodiment of this application further provides a computer-readable storage medium. The computer-readable storage medium stores computer instructions for implementing the method in the foregoing method embodiment.

For example, when a computer program is executed by a computer, the computer is caused to implement the method in the foregoing method embodiment.

An embodiment of this application further provides a computer program product including instructions. When the instructions are executed by a computer, the computer is caused to implement the method in the foregoing method embodiment.

An embodiment of this application further provides a communication system. The communication system includes the access network device and the terminal device in the foregoing embodiments.

An embodiment of this application further provides a chip apparatus including a processor. The processor is configured to invoke a computer program or computer instructions stored in a memory, to cause the processor to perform the method in the embodiments shown in FIG. 2 to FIG. 9C.

In an embodiment, an input of the chip apparatus corresponds to the receiving operation in the embodiments shown in FIG. 2 to FIG. 9C, and an output of the chip apparatus corresponds to the sending operation in the embodiments shown in FIG. 2 to FIG. 9C.

In an embodiment, the processor is coupled to the memory through an interface.

In an embodiment, the chip apparatus further includes the memory, and the memory stores the computer program or the computer instructions.

The foregoing processor may be a general-purpose central processing unit, a microprocessor, an application-specific integrated circuit (ASIC), or one or more integrated circuits configured to control program execution of the method in the embodiments shown in FIG. 2 to FIG. 9C. The memory mentioned in any one of the foregoing may be a read-only memory (ROM), another type of static storage device that can store static information and instructions, a random access memory (RAM), or the like.

It may be clearly understood by one of ordinary skilled in the art that, for convenient and brief description, for explanations and beneficial effects of related content in any one of the communication apparatuses provided above, refer to the corresponding method embodiment provided above. Details are not described herein again.

In embodiments of this application, the terminal device or the access network device may include a hardware layer, an operating system layer running above the hardware layer, and an application layer running above the operating system layer. The hardware layer may include hardware such as a central processing unit (CPU), a memory management unit (MMU), and an internal memory (also referred to as a main memory). An operating system at the operating system layer may be any one or more computer operating systems that implement service processing through a process, for example, a Linux operating system, a Unix operating system, an Android operating system, an iOS operating system, or a Windows operating system. The application layer may include applications such as a browser, an address book, word processing software, and instant messaging software.

It may be clearly understood by one of ordinary skilled in the art that, for the purpose of convenient and brief description, for a detailed working process of the foregoing system, apparatus, and unit, refer to a corresponding process in the foregoing method embodiment, and details are not described herein again.

In the several embodiments provided in this application, it should be understood that, the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units may be integrated into one unit. The foregoing integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions in this application essentially, the part contributing, or all or a part of the technical solutions may be implemented in a form of a software product. The computer software product is stored in a storage medium, and includes several instructions for instructing a computer device (which may be a personal computer, a server, or an access network device) to perform all or a part of the steps of the methods in embodiments of this application. The foregoing storage medium includes: any medium that can store program code, for example, a USB flash disk, a removable hard disk, a read-only memory, a random access memory, a magnetic disk, or an optical disc.

1. A sensing method, comprising:
obtaining at least two sets of parameter configurations, comprising a first parameter configuration for sensing and a second parameter configuration for sensing, wherein the first parameter configuration comprises a first subcarrier spacing (SCS), the second parameter configuration comprises a second SCS, and the first SCS is greater than the second SCS; and
performing sensing based on the at least two sets of parameter configurations.

2. The method according to claim 1, wherein the first SCS is a largest SCS in SCSs supported by at least one frequency band in an active state.

3. The method according to claim 1, wherein the first SCS is one SCS in SCSs supported by a frequency band in an inactive state, and the one SCS supported by the frequency band in the inactive state is greater than an SCS supported by a frequency band in an active state.

4. The method according to claim 1, wherein the first parameter configuration further comprises a first cyclic prefix (CP), the second parameter configuration further comprises a second CP, the first CP corresponds to the first SCS, the second CP corresponds to the second SCS, and the first CP is less than the second CP.

5. The method according to claim 4, wherein the first CP is a first product; and the first product is a product of a normal CP corresponding to the first SCS and α, and 0≤α<1.

6. The method according to claim 4, wherein the second CP is a second product; and the second product is a product of a normal CP corresponding to the second SCS and β, or a product of a physical random access channel (PRACH) CP corresponding to the second SCS and β, and β>1.

7. The method according to claim 4, wherein the first parameter configuration further comprises a length of a first receive window; and the length of the first receive window is not less than a sum of a length of a first symbol and twice a length of the first CP, and the length of the first symbol is a reciprocal of the first SCS; or
the length of the first receive window is N times the length of the first symbol, and N>1.

8. The method according to claim 4, wherein the second parameter configuration further comprises a length of a second receive window; and the length of the second receive window is not less than a sum of a length of a second symbol and twice a length of the second CP, and the length of the second symbol is a reciprocal of the second SCS; or
the length of the second receive window is not less than a sum of twice the length of the second CP and a length of (M+1) second symbols, M is an integer, and M≥2.

9. The method according to claim 1, wherein a length of a transmit symbol of a sensing signal obtained based on the second parameter configuration is not greater than the length of the first receive window, and the first receive window is a receive window of a sensing signal using the first parameter configuration.

10. The method according to claim 1, wherein the method further comprises:
receiving first indication information indicating start time of the receive window of a sensing signal using the first parameter configuration and/or start time of a receive window of the sensing signal using the second parameter configuration.

11. The method according to claim 1, wherein the first parameter configuration further comprises at least one of a first guard period (GP), a second GP, or a third GP, and the second parameter configuration further comprises at least one of the first GP, the second GP, or the third GP, wherein
the first GP is a GP between a sensing resource and a communication resource that are intra-frequency;
the second GP is a GP between a sensing resource and a communication resource that are inter-frequency, or the second GP is a GP between a first sensing resource and a second sensing resource that are inter-frequency; and
the third GP is a time interval between a transmit symbol of a sensing signal and start time of a corresponding receive window, and a length of the time interval is greater than a first threshold.

12. The method according to claim 11, wherein the method further comprises:
receiving second indication information indicating the length of the time interval.

13. The method according to claim 11, wherein a sensing resource of a first sensing signal in a time range of the third GP is for transmission of a communication signal or a channel, or the sensing resource of the first sensing signal in the time range of the third GP is for transmission of a second sensing signal or a channel.

14. The method according to claim 1, wherein the first parameter configuration further comprises a first repeated transmission interval, the second parameter configuration further comprises a second repeated transmission interval, and the first repeated transmission interval is less than the second repeated transmission interval, wherein the first repeated transmission interval indicates a transmission interval of a sensing signal or channel using the first parameter configuration, and the second repeated transmission interval indicates a transmission interval of a sensing signal or channel using the second parameter configuration.

15. The method according to claim 14, wherein the second repeated transmission interval is an integer multiple of the first repeated transmission interval.

16. The method according to claim 1, wherein a sensing signal determined based on the first parameter configuration is transmitted on a first beam, and the sensing signal determined based on the second parameter configuration is transmitted on a second beam; or
the sensing signal determined based on the first parameter configuration and the sensing signal determined based on the second parameter configuration are transmitted on the first beam in a first time period, and transmitted on the second beam in a second time period, wherein the first time period and the second time period do not overlap with each other.

17. The method according to claim 1, wherein the first parameter configuration further comprises information about a time domain resource for sensing and information about a frequency domain resource for sensing, wherein the information about the time domain resource indicates a time domain resource for transmission of a sensing signal, and the information about the frequency domain resource indicates a frequency domain resource for transmission of a sensing signal.

18. The method according to claim 1, wherein performing sensing based on the at least two sets of parameter configurations comprises:
performing sensing on a first frequency band based on the first parameter configuration; and
performing sensing on a second frequency band based on the second parameter configuration.

19. An apparatus, comprising:
a processor, and
a memory coupled to the processor to store instructions, which when executed by the processor, cause the apparatus to:
obtain at least two sets of parameter configurations comprising a first parameter configuration for sensing and a second parameter configuration for sensing, wherein the first parameter configuration comprises a first subcarrier spacing (SCS), the second parameter configuration comprises a second SCS, and the first SCS is greater than the second SCS; and
perform sensing based on the at least two sets of parameter configurations.

20. A non-transitory machine-readable storage medium having instructions stored therein, which when executed by a processor, cause the processor to:
obtain at least two sets of parameter configurations comprising a first parameter configuration for sensing and a second parameter configuration for sensing, wherein the first parameter configuration comprises a first subcarrier spacing (SCS), the second parameter configuration comprises a second SCS, and the first SCS is greater than the second SCS; and
perform sensing based on the at least two sets of parameter configurations.
